(19) United States
(12) Patent Application Publication
(10) Pub. No.: US 2011/0191687 A1
(43) Pub. Date: Aug. 4, 2011

(54) MOBILE TERMINAL

(75) Inventors: Kentaro TAKEDA, Tokyo (JP); Marvin BONI ANG GAW GO, Hachioji-shi (JP); Natsuki NOSE, Saitama-shi (JP)

(73) Assignee: KABUSHIKI KAISHA TOSHIBA, Tokyo (JP)

(21) Appl. No.: 12/852,634

(22) Filed: Aug. 9, 2010

(30) Foreign Application Priority Data
Jan. 29, 2010 (JP) 2010-019622
Jan. 29, 2010 (JP) 2010-019623
May 24, 2010 (JP) 2010-118622

(51) Int. Cl. G06F 15/177

(52) U.S. Cl. 715/736

(57) ABSTRACT

According to one embodiment, a mobile terminal capable of viewing a Web page, as described in embodiments, comprises a storing unit configured to store an access history of the Web page, and a history recording unit configured to record the access history of the Web page in the storage unit and, upon moving from the Web page to a Web page having other identification information after access, record an access history of the Web page corresponding to the other identification information in the storage unit.

### CROSS-REFERENCE TO RELATED APPLICATIONS

This application is based upon and claims the benefit of priority from Japanese Patent Applications No. 2010-019622, filed Jan. 29, 2010; No. 2010-019623, filed Jan. 29, 2010; and No. 2010-118622, filed May 24, 2010; the entire contents of all of which are incorporated herein by reference.

### FIELD

Embodiments described herein relate generally to a mobile terminal.

### BACKGROUND

Recently, a cellular telephone has been equipped with various functions such as management of an address book, transmission and reception of electronic mails, a Web browsing function, multimedia reproduction, digital camera, GPS (Global Positioning System) receiving function and the like, besides speech conversation. These can be implemented by mounting hardware and application software corresponding to the functions, and allowing the user to arbitrarily select and execute the application software.

In addition, by aligning and displaying a number of icons corresponding to the application software, electronic files formed by the application software, Web URL (Uniform Resource Locator) and the like, on a screen and allowing the user to select the icons, the application software can be activated, the application software corresponding to electronic files can be activated to open the electronic files, and the browser software can be activated to access sites corresponding to the URL.

However, if a number of displayed icons are increased, icons of higher frequency of use are not displayed necessarily. The icons can be rearranged in an arbitrary order. Since the frequency of use is dynamically changed, resetting the arrangement of the icons is of low convenience for the user.

On a conventional menu table displaying a list of application software, the order of display on the table has been changed in accordance with the frequency of use (for example, Jpn. Pat, Appln. KOKAI Publication No. 2006-039615).

### BRIEF DESCRIPTION OF THE DRAWINGS

FIG. 1 is a block diagram showing a structure of an embodiment of a mobile terminal;

FIG. 2 is an illustration showing an example of general icon display of the mobile terminal shown in FIG. 1;

FIG. 3 is a table showing an example of a use history data 50c shown in FIG. 1;

FIG. 4 is a table showing an example of use history data 50c shown in FIG. 1;

FIG. 5 is a table showing an example of use history data 50c shown in FIG. 1;

FIG. 6 is a table showing an example of total evaluation value data 50d shown in FIG. 1;

FIG. 7 is a table showing an example of final use history data 50f shown in FIG. 1;

FIG. 8 is a flowchart showing a recommendation display control of the mobile terminal shown in FIG. 1;

FIG. 9 is a flowchart showing database updating processing of the recommendation display control shown in FIG. 8;

FIG. 10 is a flowchart showing recommendation display processing of the recommendation display control shown in FIG. 8;

FIG. 11 is an illustration showing an example of a recommendation display displayed by the recommendation display processing shown in FIG. 10;

FIG. 12 is an illustration showing an example of a recommendation display displayed by the recommendation display processing shown in FIG. 10;

FIG. 13 is a flowchart showing generation processing of Web access history data 50g shown in FIG. 1;

FIG. 14 is a table showing an example of Web access history data 50g shown in FIG. 1;

FIG. 15 is a flowchart showing abbreviation processing shown in FIG. 9;

FIG. 16 is a flowchart showing database updating processing of the recommendation display control shown in FIG. 8;

FIG. 17 is a flowchart showing generation processing of Web access history data 50g shown in FIG. 1;

FIG. 18 is a block diagram showing a structure of an embodiment of a mobile terminal;

FIG. 19 is a table showing an example of variation amount data 50h shown in FIG. 8;

FIG. 20 is a flowchart showing a Web recommendation display control of the mobile terminal shown in FIG. 18;

FIG. 21 is a flowchart showing URL specifying processing of the Web recommendation display control shown in FIG. 20;

FIG. 22 is a flowchart showing URL depth counting processing of the Web recommendation display control shown in FIG. 20; and

FIG. 23 is a flowchart showing Web recommendation display processing of the mobile terminal shown in FIG. 18.

### DETAILED DESCRIPTION

In general, according to one embodiment, an mobile terminal includes a storing unit and a history recording unit. The storing unit is configured to store an access history of the Web page. The history recording unit is configured to record the access history of the Web page in the storage unit and, upon moving from the Web page to a Web page having other identification information after access, record an access history of the Web page corresponding to the other identification information in the storage unit.

### First Embodiment

A first embodiment will be described below with reference to the accompanying drawings.

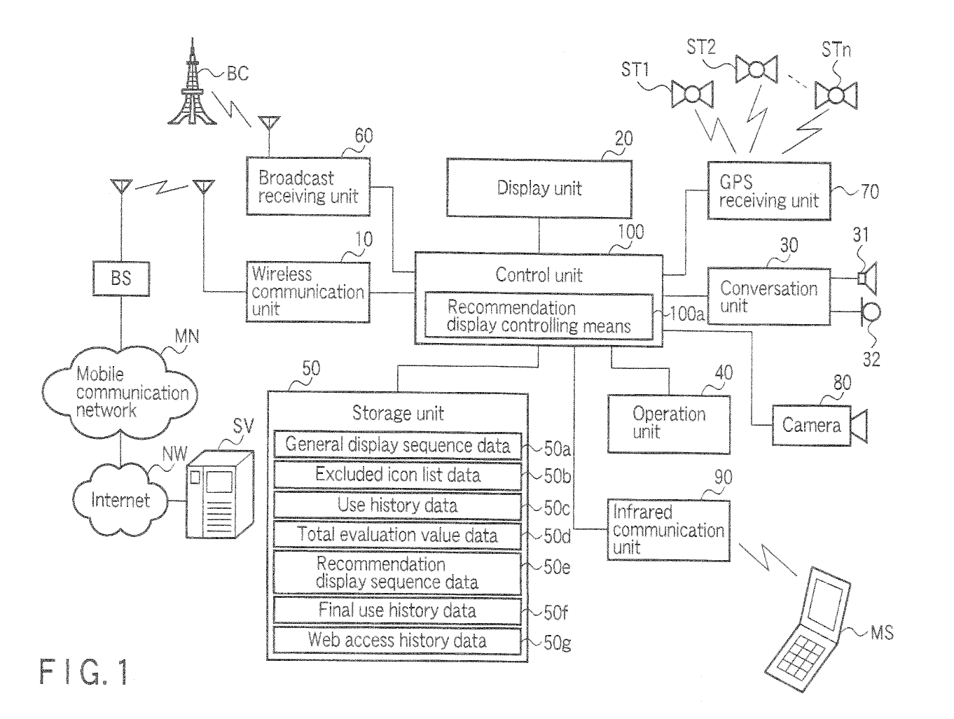

FIG. 1 is a block diagram showing a structure of a mobile terminal according to the first embodiment. In the following descriptions, a multifunctional cellular telephone, i.e., smartphone is exemplified as the mobile terminal.

As shown in FIG. 1, the mobile terminal comprises a control unit 100, a wireless communication unit 10, a display unit 20, a conversation unit 30, an operation unit 40, a storage unit 50, a broadcast receiving unit 60, a GPS receiving unit 70, a digital camera 80, and an infrared communication unit 90 as main constituent elements. As main functions, the mobile terminal comprises a communication function of executing speech communication and data communication via a base station apparatus BS and a mobile communication network MN, a broadcast reception function of receiving ground digital broadcast signal transmitted from a broadcast station BS, a positioning function of positioning an own position, and an infrared communication function of executing infrared communication with the other mobile telephone MS, and also comprises a function of executing application software using these functions. Besides these functions, the mobile terminal comprises a function of executing credit-card transactions by non-contact type near-distance wireless communication such as Blue moth (registered trademark), an electronic money function of payment for use of transportation and product purchase, and the like.

The wireless communication unit 10 executes wireless communications with the base station apparatus BS accommodated in the mobile communication network MN, under instructions of the control unit 100, and thereby executes the transmission and reception of speech data and electronic mail data and the reception of Web data, streaming data, and the like.

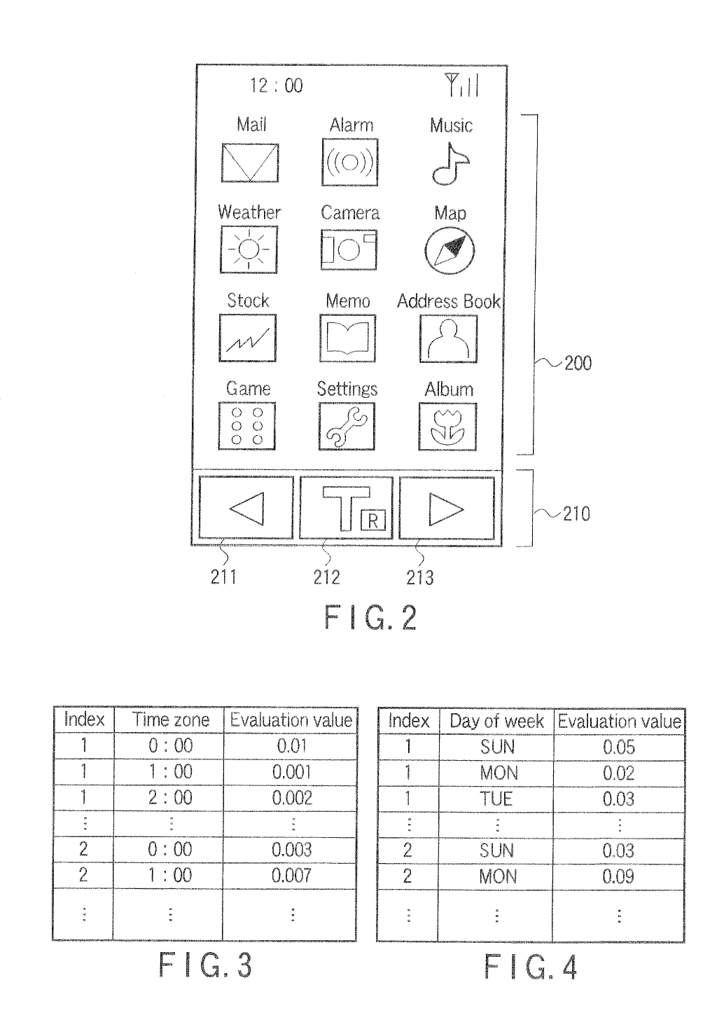

The display unit 20 displays images (still images and moving images), character information, and the like and visually transmits the information to the user, under control of the control unit 100. As shown in FIG. 2, for example, a number of icons corresponding to the application software, electronic files created by the application software, Web URL (Uniform Resource Locator), and the like are arranged and displayed in an icon display area 200, and software keys having functions assigned thereto are displayed in a function key display area 210.

The conversation unit 30 comprises a speaker 31 and a microphone 32, converts user's speech input through the microphone 32 into speech data which can be processed by the control unit 100 and outputs the speech data to the control unit 100, and decodes speech data received from a conversation counterpart, and the like via the wireless communication unit 10 and outputs the decoded speech data from the speaker 31.

The operation unit 40 comprises a plurality of key switches, and the like and a touch panel provided on the display unit 20, and accepts the instructions from the user through the touch panel. The touch panel may be in a resistance film type, an electrostatic capacitance type, an electromagnetic inductance type, and the like. Coordinates on the touch panel operated by the user are detected, and the control unit 100 is notified of the coordinates.

On the basis of the coordinates notified by operation unit 40, the control unit 100 detects an icon or a function key displayed in the display area on the display unit 20, corresponding to the coordinates, and recognizes an operation for this. As for the operation, the control unit 100 detects single-click, double-click, drag, action based on multipoint contact, and the like, and recognizes and executes instructions intended by the user (selection, execution, movement, expansion and reduction of display, screen slide (page ejection), and the like.)

The storage unit 50 stores control programs and control data of the control unit 100, application soft are address data associated with names, telephone numbers, and the like of the other communication parties, data of transmitted and received emails, Web data downloaded by Web browsing, and downloaded content data, and temporarily stores streaming data, and the like. The storage unit 50 comprises one or more storage unit such as HDD, and semiconductor memories of RAM, ROM, and the like.

In addition, the storage unit 50 stores excluded icon list data 50b, use history data 50c, total evaluation value data 50d, recommendation display sequence data 50e, final use history data 50f, and Web access history data 50g as control data to implement recommendation display control to be described later, besides general display sequence data 50a.

The general display sequence data 50a are information indicating a sequence of displaying identification information of icons (hereinafter called icon index or, simply, index, abbreviated as index in the drawings) corresponding to the application software, electronic files created by the application software, URL of Web pages, and the like, on an icon display area 200 if the recommendation display control is not executed. An icon table associating the icon index, and icons, with application software, electronic files, or URL of Web pages is stored in the storage unit 50 though not shown.

The excluded icon list data 50b are information in which, if the recommendation display control is executed, the icon index of the icons to be excluded from the control is listed. More specifically, a minimum (for example, lower than 0) evaluation value is associated with the icon index if a low priority is set while a maximum (for example, 100) evaluation value is associated with the icon index if a high priority is set. The icons are thereby displayed in the icon display area 200 in subsequent processing, with the low priority or high priority neglecting the recommendation display control.

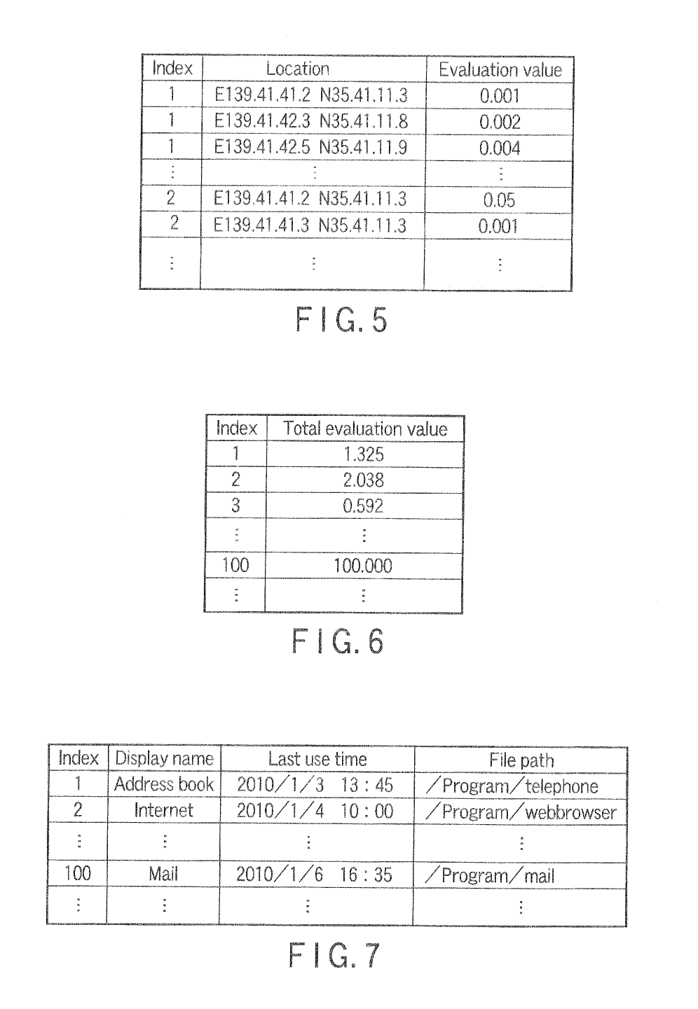

In the use history data 50c, a use (execution) history of each icon is recorded as exemplified in FIG. 3 to FIG. 5. The use history data 50c include a use time zone management table to manage a time zone of use in association with the icon index as shown in FIG. 3, a use day-of-week management table to manage a day of the week of use in association with the icon index, a use location management table to manage a location of use (latitude and longitude) in association with the icon index, and the like. An evaluation value regarded as a base of calculation of the priority in the sequence of display is associated with each icon index.

In the example of FIG. 3, the time zone of use is divided and the evaluation value of each time zone of use is managed, in a unit of one hour, but the embodiment is not limited to this. The evaluation value may be managed in a unit of the time shorter than one hour or longer than one hour. In addition, in the example of FIG. 4, the evaluation value is managed by the day of the week, but the embodiment is not limited to this. The evaluation value may be managed in a unit of day, week or month. In addition, since it is assumed that the position information rarely coincides completely with each other, the information may be grouped and managed in a unit of area divided in a predetermined size.

In the total evaluation value data 50d, the evaluation value is summed up by icon index by totally using each of the table stored as the use history data 50c. An example thereof is shown in FIG. 6. The evaluation value is summed up by the control unit 100. The evaluation values of the respective tables are weighted and added to obtain the total evaluation value.

The recommendation display sequence data 50e are data indicating the sequence of displaying the icons, as determined on the basis of the total evaluation value data 50d by the control unit 100. The general display sequence data 50a and the recommendation display sequence data 50e are independently managed, and the icons included in the data do not need to coincide with each other.

The final use history data 50f are data indicating association of the time when the icon is last used with information representing a file path of the icon, in relation to the icon index. An example thereof is shown in FIG. 7.

The Web access history data 50g are data in which the URL accessed by the browser software, the Web title, the access time and the icon are associated and stored as an access history of the Web page.

The broadcast receiving unit 60 receives one segment of the ground digital broadcast signal transmitted from a broadcast station BC, and obtains broadcast data (encoded stream) generated by encoding the image signal in a format such as H.264. The broadcast receiving unit 60 receives one segment of a low frame rate in the case exemplified here, but the embodiment is not limited to this. A digital tuner for receiving full segments of a higher frame rate may be employed. The broadcast station BC may be a general broadcast station for broadcasting in a wide range or a broadcast station which limits the receiving area to a specific area such as a large store, public facilities, and the like.

The GPS receiving unit 70 receives GPS (Global Positioning System) signals transmitted from CPS satellites ST1 to STn and measures a position (latitude, longitude, height), and also outputs the position information (latitude, longitude, height) obtained by the measurement to the control unit 100.

The digital camera 80 is a digital camera for taking an image with an image pickup device such as CCD (Charge-Coupled Device) or CMOS (Complementary Metal Oxide Semiconductor). The digital camera 80 is controlled by the control unit 100 to output image data obtained by the image pickup device to the control unit 100.

The infrared communication unit 90 executes infrared communications with an opposed device (for example, other cellular telephone MS) having an infrared communication function, and has its operation set by the control unit 100. The infrared communication unit 90 transmits the transmission data supplied from the control unit 100 by infrared light, receives data transmitted from the opposed device by infrared light, and outputs the received data to the control unit 100 as reception data.

The control unit 100 comprises a microprocessor, operates under the control programs and control data stored in the storage unit 50, and controls each of the units in the mobile radio terminal. The control unit 100 also comprises, for example, a communication controlling function for controlling each of the units of the commutation system to execute the speech communication and data communication, and an application processing function for executing nail software which creates, transmits and receives electronic mails, browser software which executes Web browsing, media reproduction software which downloads and reproduces streaming data, broadcast reception software which receives the ground digital broadcast signal transmitted from the broadcast station BC, image processing software which controls the digital camera 80 to execute photographing, and image analysis software which decodes a QR (Quick Response) code (registered trademark) by image analysis, and controlling each of the units associated with the software.

In addition, the control unit 100 detects an operation for the icon displayed on the display unit 20 on the basis of the detection result of the operation unit 40. If the operation requires activation, the control unit 100 executes a function associated with the icon.

For example, if the application software is associated with the operated icon, the control unit 100 reads out the associated application software from the storage unit 50 and executes the associated application software.

In addition, for example, if an electronic file is associated with the operated icon, the control unit 100 reads out the application software for using (viewing or editing) the associated electronic file from the storage unit 50 and executes the application software.

For example, if the URL of the Web page is associated with the operated icon, the control unit 100 activates the browser software, starts communications by unit of the wireless communication unit 10, accesses a server SV storing the information corresponding to the URL over the Internet NW to obtain Web data and the like, and urges the information to be displayed on the display unit 20 by the browser software. In other words, the control unit 100 accesses the URL and allows the user to view the information.

The control unit 100 comprises recommendation display controlling unit 100a. This function is implemented by reading and executing the recommendation display control application stored in the storage unit 50 by the control unit 100. The icon display is executed in a sequence corresponding to the user's use history instead of the icon display in the general sequence as shown in FIG. 2 (at the time of not executing the recommendation display control).

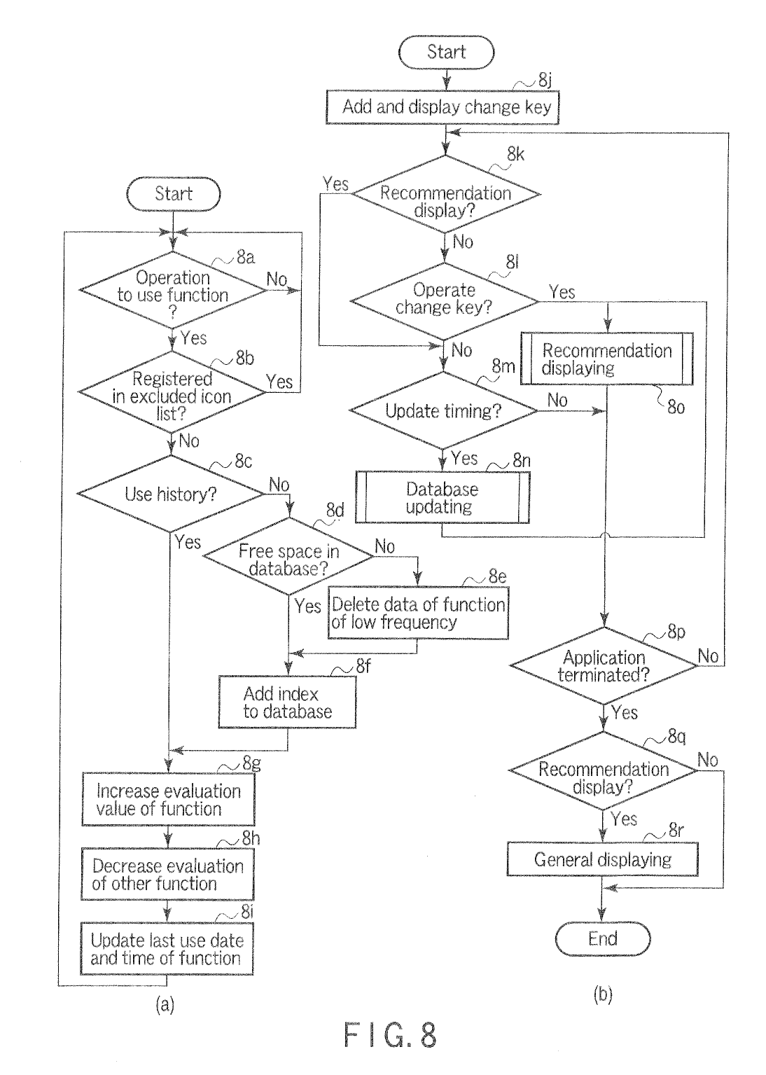

Next, the operation of the mobile terminal according to the first embodiment will be described. The following descriptions are particularly focused on the operation of the recommendation display control. FIG. 8 is a flowchart showing the operation of the recommendation display control. A first process shown in FIG. 8(a) and a second process shown in FIG. 8(b) are executed simultaneously.

These processes are executed by unit of the recommendation display controlling unit 100a, by reading and executing the recommendation display control application stored in the storage unit 50 by the control unit 100. When the user requests the execution of the recommendation display control application by unit of the operation unit 40, the processes are started.

The control unit 100 allows the icons and the like corresponding to the application software, electronic files generated by the application software, URL of the Web pages and the like to be displayed in the icon display area 200, in the arrangement based on the general display sequence data 50a, before the request for execution is supplied.

First, the first process will be described with reference to FIG. 8(a). This process is repeated until the control unit 100 terminates the operation.

In step 8a, the recommendation display controlling unit 100a monitors the operation for the operation unit 40 and determines whether the operation for an icon (for example, double click) is executed by the user and whether an instruction for using the function is executed, by unit of the operation unit 40. If it is detected that the instruction for using the function is executed, the process shifts to step 8b. If it is not detected that the instruction for using the function is executed, the process shifts to 8a to execute the determination again.

In step 8b, the recommendation display controlling unit 100a refers to the excluded icon list data 50b and determines whether the index of the icon operated in step 8a is registered in the excluded icon list data 50b or not. If the index is registered in the excluded icon list data 50b, the process shifts to step 8a. If the index is not registered in the excluded icon list data 50b, the process shifts to step 8c.

In step 8c, the recommendation display controlling unit 100a refers to the use history data 50c and determines whether the table including the index of the icon operated in step 8a is present the use history data 50c or not. If the table is present, the process shifts to step 8g. If the table is not present, the process shifts to step 8d.

In step 8d, the recommendation display controlling unit 100a refers to each table of the use history data 50c and determines whether information of a new icon index can be added or not, i.e. whether the table includes a free space or not. If the free space is present, the process shifts to step 8f. If the free space is not present, the process shifts to step 8e.

In step 8e, the recommendation display controlling unit 100a refers to the table of the final use history data 50f, detects an icon index which is used in oldest period and which is presumed to have a low frequency of use, deletes information corresponding to the icon index in each table and generates a free space. The process shifts to step 8f.

The recommendation display controlling unit 100a may refer to the table of the final use history data 50f, detect an icon index of the lowest frequency of appearance, delete the information corresponding to the icon index in each table and generate a free space. Alternatively, the recommendation display controlling unit 100a may refer to both of the use history data 50c and the use history data 50c and delete the icon index of a lower frequency of use.

In step 8f, the recommendation display controlling unit 100a adds the index of the icon operated in step 8a to each table of the use history data 50c. The process shifts to step 8g.

In step 8g, the recommendation display controlling unit 100a raises (increases) an evaluation value corresponding to the index of the icon operated in step 8a, in each table of the use history data 50c. The process shifts to step 8h. For example, in the use time zone management table, the recommendation display controlling unit 100a obtains a time at which the use of a function of the icon is started, from a time which is counted by the control unit 100, and raises the evaluation value of the use time zone the obtained time corresponding to the index of the icon operated in step 8a.

As for the use day-of-week management table, the control unit 100 obtains a day of week of the time at which the use of the icon is started, on the basis of the counted time, and raises the evaluation value of the day of week corresponding to the index of the icon operated in step 8a. As for the use location management table, the GPS receiving unit 70 obtains position information of the time at which the use of the icon is started, on the basis of the measured position information, and raises the evaluation value of the position corresponding to the index of the icon operated in step 8a.

In step 8h, the recommendation display controlling unit 100a lowers (reduces) an evaluation value corresponding to an index other than the index of the icon operated in step 8a, in each table of the use history data 50c. The process shifts to 8i.

In step 8i, the recommendation display controlling unit 100a obtains daze and time at which the use of the function corresponding to the icon is started, from the time counted by the control unit 100, associates the obtained time with the icon index as a final use time, and records the time in the final use history data 50f. The process shifts to 8a. The recommendation display controlling unit 100a may detect not the date and time of the start of use, but the time of the end of use and record the time in the final use history data 50f.

Next, the second process will be described with reference to FIG. 8(b).

In step 8j, the recommendation display controlling unit 100a allows a change key 212 to be displayed in the function key display area 210, as shown in FIG. 2. In accordance with the display of the change key 212, other function keys 211, 213 such as a page feed key and the like are displayed in the function key display area 210. The process shifts to step 8k.

In step 8k, the recommendation display controlling unit 100a determines whether it is a status in which a recommendation display is executed by recommendation display processing in step 8o to be described later or not. If it is the status in which the recommendation display is executed, the process shifts to step 8m. If it is not the status in which the recommendation display is executed, the process shifts to step 8l.

In step 8l, the recommendation display controlling unit 100a monitors the operation to the operation unit 40 and determines whether the operation to the change key 212 displayed in step 8j is operated by the user or not, i.e. whether a request for change to the recommendation display is made or not. It the request for change to the recommendation display is detected, the process shifts to step 8o. If the request for change to the recommendation display is detected, the process shifts to step 8m.

In step 8m, the recommendation display controlling unit 100a determines whether a timing for updating the recommendation display sequence data 50e comes or not. In other words, the control unit 100 monitors a time elapsing from the previous updating and determines whether the elapsed time exceeds a preset value or not. If the timing for updating comes, the process shifts to step 8n. If the timing for updating does not come, the process shifts to step 8p.

The control unit 100 determines YES in step 8m every time one hour passes in the example shown in FIG. 3, and every time 0 o'clock AM comes in the example shown in FIG. 4. Alternatively, the control unit 100 may monitor the detection result of the GPS receiving unit 70, and the processing in step an may be started if the area in which the mobile terminal is present is changed in longer than a predetermined distance, i.e., if Yes is detected in step 8a.

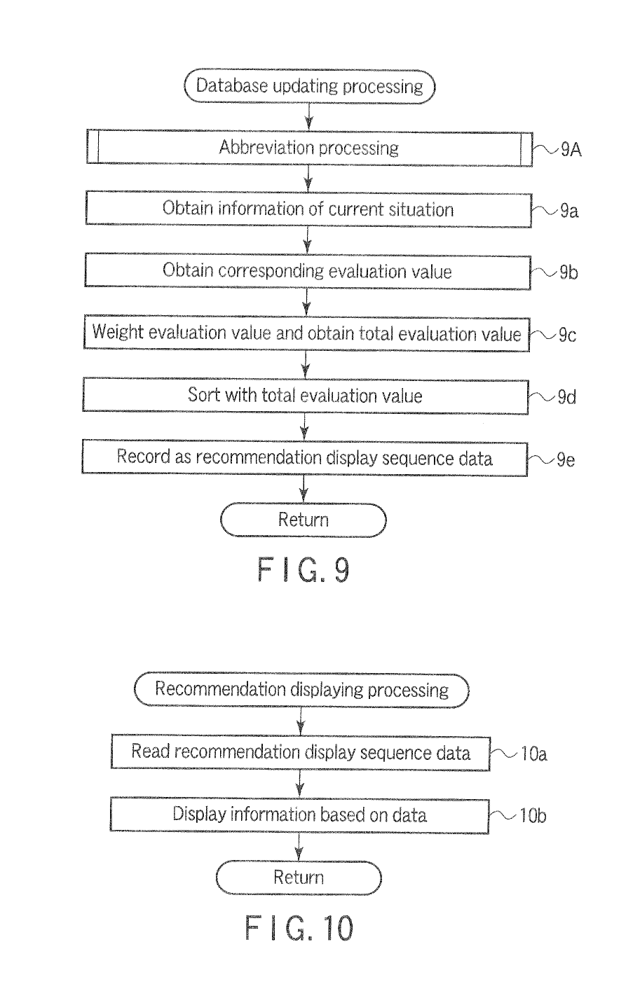

In step 8n, the recommendation display controlling unit 100a executes updating processing for updating the recommendation display sequence data 50e. The process shifts to step 8o. The updating processing will be described later with reference to FIG. 9.

In step 8o, the recommendation display controlling unit 100a executes recommendation display processing on the basis of the recommendation display sequence data 50e. The process shifts to step 8p. The recommendation display processing will be described later with reference to FIG. 10.

In step 8p, the recommendation display controlling unit 100a determines whether the user executes an operation for terminating the recommendation display controlling application by unit of the operation unit 40 or not. If it is detected that the terminating operation is executed, the process shifts to step 8q. If it is not detected that the terminating operation is executed, the process shifts to step 8k.

In step 8r, the recommendation display controlling unit 100a determines whether it is a status in which the recommendation display is executed by the recommendation display processing in step 8o or not. If it is the status in which the recommendation display is executed, the process shifts to step 8r. If it is not the status in which the recommendation display is executed, the process is terminated.

In step 8q, the recommendation display controlling unit 100a allows the icons corresponding to the application software, electronic files generated by the application software, the URL of the Web pages and the like to be displayed in the icon display area, terminates the process, and assigns an authority relating to the icon display control to the control unit 100.

Next, the updating processing in step 8m will be described with reference to FIG. 9.

First, in step 9A, the recommendation display controlling unit 100a executes abbreviation processing relating to Web access, on the basis of the Web access history data 50g. The processing shifts to step 9a. The abbreviation processing will be described later.

In step 9a, the recommendation display controlling unit 100a obtains information of current conditions. The processing shifts to step 9b. In other words, the recommendation display controlling unit 100a obtains time information indicating a current time from the control unit 100, and obtains position information indicating a current position from the GPS receiving unit 70.

In step 9b, the recommendation display controlling unit 100a refers to each table included in the use history data 50c and detects sets of all the indexes corresponding to the current conditions (time information and position information) obtained in step 9a and evaluation values corresponding to the indexes. The processing shifts to step 9c.

In step 9c, the recommendation display controlling unit 100a applies different weights to the evaluation values detected in step 9b, in each table, and adds and sums the evaluation values for each index. The recommendation display controlling unit 100a records the result of summing the evaluation values for each index and the total evaluation value recorded in the excluded icon list data 50b, as a total evaluation value for each index, over the total evaluation value data 50d. The processing shifts to step 9d. The weighting may be arbitrarily preset by the user. If the evaluation values of different tables are to be handled equivalently, the same values may be set as the weights.

In step 9d, the recommendation display controlling unit 100a refers to the information recorded in the total evaluation value data 50d, and executes sorting processing for rearranging each of the total evaluation values and the index corresponding to the total evaluation value in a sequence of higher total evaluation values. The processing shifts to step 9e.

In step 9e, the recommendation display controlling unit 100a records the information (each total evaluation value and the index corresponding to the total evaluation value) sorted in a sequence of a higher total evaluation value in step 9d, over the recommendation display sequence data 50e, and terminates the processing. The processing shifts to step 8o.

Next, the recommendation display processing in step 8n will be described with reference to FIG. 10.

First, in step 10a, the recommendation display controlling unit 100a reads the recommendation display sequence data 50e. The processing shifts to step 10b.

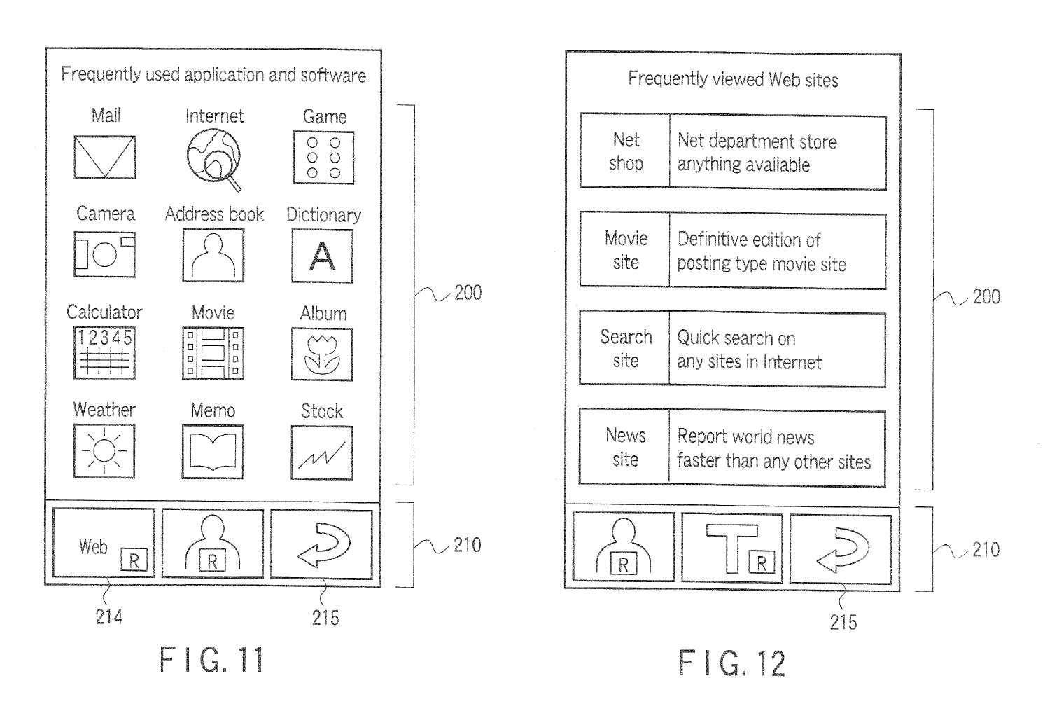

In step 10b, the recommendation display controlling unit 100a urges the index of a higher corresponding total evaluation value to be displayed on the icon display area 200 with priority, on the basis of the recommendation display sequence data 50e read in step 10a, and terminates the processing. For example, the icons displayed in a sequence shown in FIG. 2 are displayed from upper left to right, and then to a lower row in the order on the icon display area 200, as shown in FIG. 11.

In other words, in an example of FIG. 11, an icon represented as “mail” has a highest priority and, subsequently, the icons are displayed in a sequence of “Internet”, “game”, “camera”, “address book”, “dictionary”, “calculator”, . . . “stock price” with a higher priority. If, for example, “mail” of these icons is set to have a higher priority in the excluded icon list data 50b and an excessively great total evaluation value is set, the icon is displayed at an upper position irrespective of its use frequency. On the contrary, if an excessively small total evaluation value is set, the icon is displayed at a position of a lower priority, on a next page or following page.

If the user operates at a position of a “Web” key 214 in the function key display area 210, the recommendation display controlling unit 100a determines that the “Web” 214 has been operated, forms a list of icons corresponding to the indexes associated with the Web site, of the indexes included in the recommendation display sequence data 50e, and urges the list to be displayed in the icon display area 200 as shown in FIG. 12.

In FIG. 12, displaying title information of the Web page is exemplified. However, the control unit 100 may control the radio communication unit 10 to communicate with the Web site, obtain the latest RSS, extract meta information in the HTML page, and urge the information and information on a Web site by processing a title by the control unit 100 to be displayed. The user can thereby obtain the latest information on the Web site at a glance.

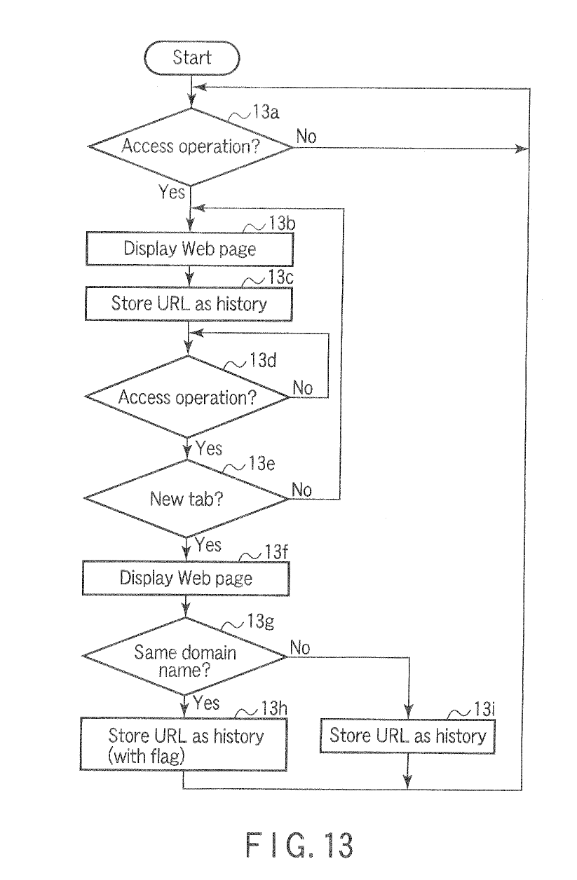

Next, processing of generating the Web access history data 50g executed upon performing Web browsing by using the browser software will be described with reference to FIG. 13. The processing shown in FIG. 13 is executed by the control unit 100 when the browser software is activated, and is repeated until the use of the browser software is stopped. The browser software used here is what is called a tab browser capable of viewing Web pages with a plurality of tabs, respectively.

First, in step 13a, the control unit 100 determines whether an operation to request an access to the Web page has been accepted by the user operation, by unit of the operation unit 40. If it is determined that the operation has been accepted, the processing shifts to step 13b. If it is determined that the operation has not been accepted, the control unit 100 continues monitoring the operation again in step 13a.

The above operation indicates, for example, an operation in a case where a URL is input to a URL input field and the access operation is executed, a case where the icon associated with the URL of the Web page is operated, or the like.

In step 13b, the control unit 100 accesses the URL of the Web page to which an access has been requested in step 13a (or step 13d to be described later) in predetermined procedures, for example, HTTP (Hyper Text Transport Protocol), obtains Web data, and urges the Web page to be displayed by unit of the browser software. Then, the processing shifts step 13c.

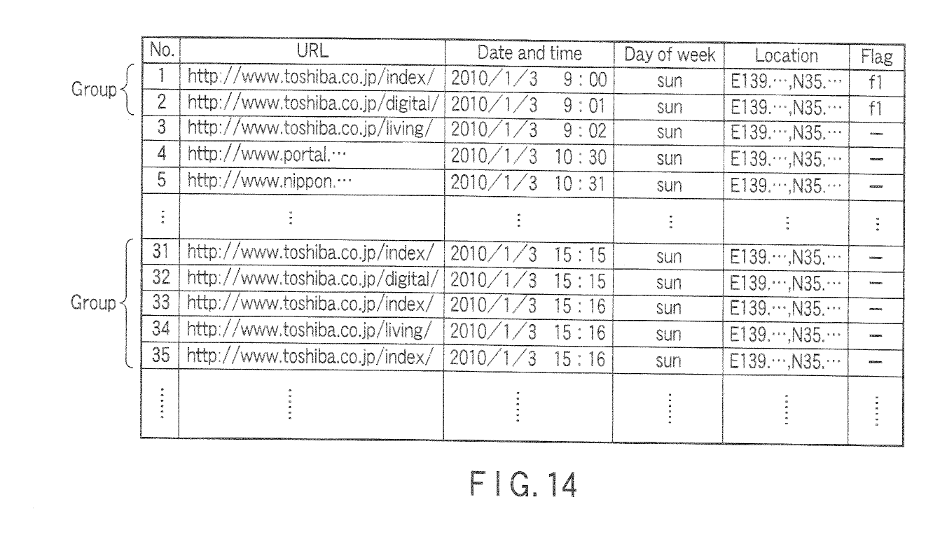

In step 13c, the control unit 100 records the URL of the Web page to which access has been requested in step 13a (or step 13d), as an access history, in the Web access history data 50g. Then, the processing shifts to step 13d. The control unit 100 also obtains information such as the time and location at which the connection has been made, and records the information in association with the access history. An example of the access history is shown in FIG. 14.

In step 13d, the control unit 100 determines whether the operation of requesting an access to the Web page has been newly accepted, by unit of the operation unit 40. If it is determined that the operation has been newly accepted, the processing shifts to step 13e. If it is determined that the operation has not been newly accepted, the control unit 100 continues monitoring the new operation again in step 13d.

In step 13e, the control unit 100 determines whether the operation determined in step 13d opens new tab screen (or new, other window) besides the screen used for browsing in step 13b and accesses the new tab screen, in the currently used browser software. In other words, the control unit 100 determines whether the operation of browsing the other Web page has been executed, by newly adding the tab screen (other window) on the Web browsing screen of the same browser software.

If it is determined that the operation has been executed, the processing shifts to step 13f. At the operation of accessing the other Web page from the window used for browsing in step 13b or the Web browsing using the other browser software, the processing shifts to step 13b.

In step 13f, the control unit 100 accesses the URL, of the Web page to which an access has been requested in step 13d, in predetermined procedures, for example, under HTTP, obtains the Web data, and urges the Web page to be displayed by unit of the new tab screen. Then, the processing shifts to step 13g.

In step 13g, the control unit 100 determines whether the domain name of the URL, browsed in step 13b is the same as the domain name of the URL browsed in step 13f. If the domain names are the same, the processing shifts to step 13h. If the domain names are not the same, the processing shifts to step 13i.

In step 13h, the control unit 100 records the URL of the Web page to which an access has been requested in step 13d, as an access history, in the Web access history data 50g. The control unit 100 also obtains information such as a time and a location at which the connection has been made, and records the information in association with the access history. The control unit 100 generates a flag common to the history recorded at this time and the history recorded in step 13c, and records the flag in the Web access history data 50g. Then, the processing shifts to step 13a. FIG. 14 shows an example of assigning flag f1 common to history No. 1 and history No. 2.

In step 13i, the control unit 100 records the URL of the Web page to which an access has been requested in step 13d, as an access history, in the Web access history data 50g. Then, the processing shifts to step 13a. The control unit 100 also obtains information such as a time and a location at which the connection. has been made, and records the information in association with the access history. An example of the access history is shown in FIG. 14.

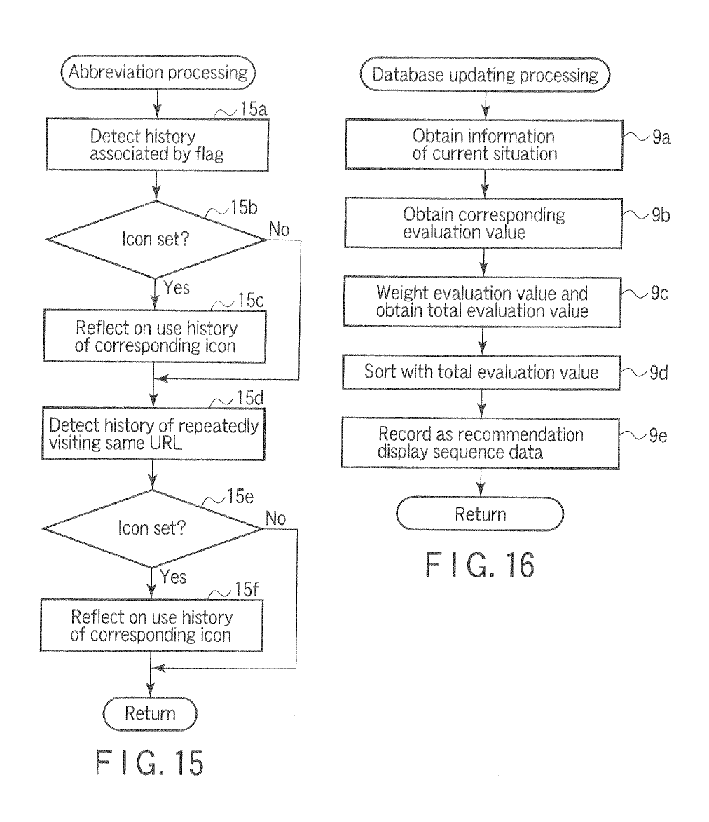

Next, the abbreviation processing shown in FIG. 9 (step 9R) will be described with reference to FIG. 15.

First, in step 15a, the recommendation display controlling unit 100a refers to the access history of a period from the execution of the previous abbreviation processing to the current time, in the Web access history data 50g, and detects a group of plurality of access histories associated with each other by the same flag. Then, the processing shifts to step 15b.

In step 15b, the recommendation display controlling unit 100a refers to the icon table stored in the storage unit 50, and detects the access history including the URL stored in the icon table, of the URL of the access histories grouped in step 15a, and also detects the icon of the access history. In other words, the recommendation display controlling unit 100a detects the access history having the URL, for which the icon is set, of the URL of the access histories in the group detected in step 15a, and also detects the icon of the access history. If no access history for which the icon is set is detected, the processing shifts to step 15d. If the access history for which the icon is set is detected, the processing shifts to step 15c.

In step 15c, the recommendation display controlling unit 100a regards the plurality of access histories grouped in step 15a as the access history of the icon detected in step 15b, and reflects the access history on the evaluation value of the use history data 50c. In other words, even if the access histories do not completely match in terms of URL, the recommendation display controlling unit 100a regards the access histories assigned the same flag as the access history of the icon detected in step 15b, and reflects the access history on the evaluation value. Then, the processing shifts to step 15d. It goes without saying that on the basis of the information such as time and location included in each access history, each of the evaluation values of the use time zone management table, use day-of-week management table, and use location management table under the corresponding conditions is increased.

In step 15d, the recommendation display controlling unit 100a refers to the Web access history data 50g, and detects the access histories in which while a plurality of accesses to the Web pages having the same URL are made in a predetermined period, or in the same window (in a case where the window identification information is also recorded in the Web access history data 50g), the Web page of the other URL is viewed and these Web pages have the same domain name, and forms a group of the access histories. Then, the processing shifts to step 15e. In the example of FIG. 14, histories No. 31 to No. 35 are grouped. In other words, histories No. 31 to No. 35 are common in terms of domain name, and histories No. 31, No. 33 and No. 35 have the same URL. It is inferred that accesses to the other We pages (histories No. 32 and No. 34) are made through the Web pages of the same URL.

In step 15e, the recommendation display controlling unit 100a refers to the icon table stored in the storage unit 50, and detects the access history including the URL stored in the icon table, of the URL of the access histories grouped in step 15d, and also detects the icon of the access history. In other words, the recommendation display controlling unit 100a detects the access history having the URL for which the icon is set, of the URL of the access histories in the group detected in step 15d, and also detects the icon of the access history. If no access history for which the icon is set is detected, the processing is terminated and shifts to step 9a. If the access history for which the icon is set is detected, the processing shifts to step 15f.

In step 15f, the recommendation display controlling unit 100a regards the plurality of access histories grouped in step 15d as the access history of the icon detected in step 15e, and reflects the access history on the evaluation value of the use history data 50c. In other words, even if the access histories do not completely match in terms of URL, the recommendation display controlling unit 100a regards the access histories assigned the same flag as the access history of the icon detected in step 15e, and reflects the access history on the evaluation value. The processing is terminated and shifts to step 9a. It goes without saying that on the basis of the information such as time and location included in each access history, each of the evaluation values of the use time zone management table, use day-of-week management table, and use location management table under the corresponding conditions is increased.

According to the mobile terminal having the above-described structure, the use histories of the functions used by the user are stored and, on the basis of the use histories, display arrangement of the icons for using the functions is controlled. Therefore, since the display arrangement of the icons is changed in accordance with the use frequency of the user, the mobile terminal has a high usability for the user.

In addition, the evaluation values indicating the frequencies of a plurality of use conditions such as the time zone of use, the day of week of use, location of use, and the like are recorded as the use histories. On the basis of the evaluation values according to the current conditions (time zone, day of week, location), the functions which would be used at a higher possibility by the user is inferred and the display arrangement of the icons is controlled.

For this reason, since the display arrangement of the icons is controlled, on the basis of the current conditions and the use histories of the past time, the mobile terminal has a high usability for the user. In addition, the functions which would be used at a higher possibility by the user are inferred by considering a plurality of conditions (time zone, day of week, location). Even if sufficient use histories are not accumulated under some of the conditions, the functions can be inferred under the other conditions. Therefore, deterioration of the usability can be restricted.

Furthermore, the total evaluation value is obtained by weighting under a plurality of conditions accumulated as the use histories, and the functions which would be used at a higher possibility by the user are inferred on the basis of the total evaluation value. For this reason, the functions can be inferred by considering the weighting under a plurality of conditions. Therefore, the user usability can be improved at a higher accuracy.

In addition, the excluded icon list data 50b are stored in the mobile terminal, and the icon index stored in the data is not subjected to the recommendation display control. For this reason, the icons can displayed except the icon index by the function of a higher use frequency or displayed with priority by the function of a lower use frequency.

In the mobile terminal having the above-described structure, if a new browsing tab (or new window) is generated from a Web page and the Web page having the same domain name is viewed again, or if a plurality of Web pages accessed sequentially have the same domain name and are viewed while repeatedly visiting a Web page of the same URL, those Web pages are regarded as one Web page and abbreviated so as to be reflected on the evaluation value of one icon.

For this reason, since viewing a Web page such as a portal site or news site as accessed temporarily is reflected on the evaluation value of the icon by which the site can be accessed, the access history can be efficiently reflected on the icon display. The user usability can be thereby improved.

The present embodiment is not limited to the embodiments described above but the constituent elements of the embodiment can be modified in various manners without departing from the spirit and scope of the embodiment. Various aspects of the embodiment can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

For example, the access histories meeting the predetermined conditions are grouped and abbreviated in the above-described embodiment. Besides this, the URL preliminarily registered in favorites may be excluded from the group.

In addition, in steps 13g to 13i, if the Web pages of the same domain name are accessed, the flag is assigned to the Web pages, the Web pages are grouped in the subsequent processing (steps 15a to 15c) such that the accesses to a plurality of Web pages are regarded as an access to a Web page corresponding to an icon, and the abbreviation processing is executed.

Alternatively, in steps 15d to 15f, the state in which the Web pages having the same domain name (for example, http://www.XXX.co.jp/digital/ or http://www.XXX.co.jp/living/) are accessed while a plurality of accesses to the Web page of the same URL (for example, http://www.XXX.co.jp/index/) are made is detected in the Web access history data 50g recorded in step 13c, the accesses to these Web pages are regarded as the access to the Web page corresponding to one icon, and the abbreviation processing is executed.

Instead of this, for example, the evaluation values of the respective date and time, day of week, and location may be stored for each URL (for example, http://www.XXX.co.jp/index/) of the Web page. After that, if it is detected that the accessed Web page has a URL of the same domain name (for example, http://www.XXX.co.jp/digital/) or if it is detected that the accessed Web pages do not have URL of the same domain name but pages including the Web page stored in the access histories are visited (for example, the pages including the page having a URL (http://www.XXX.co.jp/index/) are visited by moving from the Web page having the URL (http://www.XXX.co.jp/index/) to the Web page having a URL (http://www.YYY.co.jp/text/) and then moving to the Web page having the URL (http://www.XXX.co.jp/index/)), the access histories of the Web pages may not be stored, but the information amount based on the access histories may be abbreviated by increasing the evaluation values of the date and time, the day of week, and the location, respectively, as the history of the stored Web page (for example, http://www.XXX.co.jp/index/). According to this processing, since the access history of the Web page having the URL of the same domain name (for example, http://www.XXX.co.jp/digital/) is abbreviated, the storage capacity of the storage unit 50 can be saved. This processing is executed by the control unit 100 and the recommendation display controlling unit 100a.

In the abbreviation processing as described above, the access history of the Web page having the same domain name may be replaced with a shorter URL (or URL including a smaller number of “/”) and recorded. For example, it the evaluation values of the respective date and time, the day of week, and the location are stored for the URL of the Web page (for example, http://www.XXX.co.jp/index/digital/) and then the Web page having shorter URL (http://www.XXX.co.jp/index/) is accessed later, the URL (http://www.XXX.co.jp/index/) may be stored instead of the URL (http://www.XXX.co.jp/index/digital/). In other words, the previously stored evaluation values may be replaced with evaluation values of the URL, (http://www.XXX.co.jp/index/).

In addition, a smartphone has been exemplified in the above-described embodiment. However, the embodiment can be widely applied to devices which display the functions by the icons, such as other types of mobile telephones, PDA (Personal Digital Assistants), notebook type personal computers and the like.

It goes without saying that the present embodiment can also be variously modified within a scope which does not depart from the gist of the present embodiment.

### Second Embodiment

Next, a second embodiment will be described.

A mobile terminal according to the second embodiment has apparently the same structure as the mobile terminal according to the first embodiment shown in FIG. 1. Thus, the mobile terminal is described with reference to FIG. 1. Explanations on each constituent element are the same as the explanations on each constituent element in the above-described first embodiment, and are omitted here.

The mobile terminal according to the second embodiment comprises a control unit 100, a wireless communication unit 10, a display unit 20, a conversation unit 30, an operation unit 40, a storage unit 50, a broadcast receiving unit 60, a GPS receiving unit 70, a digital camera 80, and an infrared communication unit 90 as main constituent elements. As main functions, the mobile terminal comprises a communication function of executing speech communication and data communication via a base station apparatus BS and a mobile communication network MN, a broadcast reception function of receiving ground digital broadcast signal transmitted from a broadcast station BS, a positioning function of positioning an own position, and an infrared communication function of executing infrared communication with the other mobile telephone MS, and also comprises a function of executing application software using these functions. Besides these functions, the mobile terminal comprises a function of executing credit-card transactions by non-contact type near-distance wireless communication such as Bluetooth (registered trademark), an electronic money function of payment for use of transportation and product purchase, and the like.

Next, operations of the mobile terminal according to the second embodiment will be described. The following descriptions are particularly focused on the operation of the recommendation display control. In addition, the same operation as that in the mobile terminal according to the first embodiment is described with the drawings used in the descriptions of the first embodiment.

FIG. 8 is a flowchart showing the operation of the recommendation display control. A first process shown in FIG. 8(a) and a second process shown in FIG. 8(b) are executed simultaneously.

These processes are executed by reading and executing the recommendation display control application by the recommendation display controlling unit 100a of the control unit 100. When the user requests the execution of the recommendation display control application by unit of the operation unit 40, the processes are started.

The control unit 100 allows the icons and the like corresponding to the application software, electronic files generated by the application software, URL of the Web pages and the like to be displayed in the icon display area 200, in the arrangement based on the general display sequence data 50a, before the request for execution is supplied.

First, the first process will be described with reference to FIG. 8(a). This process is repeated until the control unit 100 terminates the operation.

In step 8a, the recommendation display controlling unit 100a monitors the operation for the operation unit 40 and determines whether the operation for an icon (for example, double click) is executed by the user and whether an instruction for using the function is executed, by unit of the operation unit 40. If it is detected that the instruction for using the function is executed, the process shifts to step 8b. If it is not detected that the instruction for using the function is executed, the process shifts to 8a to execute the determination again.

in step 8b, the recommendation display controlling unit 100a refers to the excluded icon list data 50b and determines whether the index of the icon operated in stet 8a is registered in the excluded icon list data 50b or not. If the index is registered in the excluded icon list data 50b, the process shifts to step 8a. If the index is not registered in the excluded icon list data 50b, the process shifts to step 8c.

In step 8c, the recommendation display controlling unit 100a refers to the use history data 50c and determines whether the table including the index of the icon operated in step 8a is present in the use history data 50e or not. If the table is present, the process shifts to step 8g. If the table is not present, the process shifts to step 8d.

In step 8d, the recommendation display controlling unit 100a refers to each table of the use history data 50c and determines whether information of a novel icon index can be added or not, i.e. whether the table includes a free space or not. If the free space is present, the process shifts to step 8f. If the free space is not present, the process shifts to step 8e.

In step 8e, the recommendation display controlling unit 100a refers to the table of the final use history data 50f, detects an icon index which is used in oldest period and which is presumed to have a low frequency of use, deletes information corresponding to the icon index in each table and generates a free space. The process shifts to step 8f.

The recommendation display controlling unit 100a may refer to the table of the final use history data 50f, detect an icon index of the lowest frequency of appearance, delete the information corresponding to the icon index in each table and generate a free space. Alternatively, the recommendation display controlling unit 100a may refer to both of the final use history data 50f and the use history data 50c and delete the icon index of a lower frequency of use.

In step 8f, the recommendation display controlling unit 100a adds the index of the icon operated in step 8a to each table of the use history data 50c. The process shifts to step 8g.

In step 8g, the recommendation display controlling unit 100a raises (increases) an evaluation value corresponding to the index of the icon operated in step 8a, in each table of the use history data 50c. The process shifts to step 8h. For example, in the use time zone management table, the recommendation display controlling unit 100a obtains a time at which the use of a function of the icon is started, from a time which is counted by the control unit 100, and raises the evaluation value of the use time zone the obtained time corresponding to the index of the icon operated in step 8a.

As for the use day-of-week management table, the control unit 100 obtains a day of week of the time at which the use of the icon is started, on the basis of the counted time, and raises the evaluation value of the day of week corresponding to the index of the icon operated in step 8a. As for the use location management table, the GPS receiving unit 70 obtains position information of the time at which the use of the icon is started, on the basis of the measured position information, and raises the evaluation value of the position corresponding to the index of the icon operated in step 8a.

In step 8h, the recommendation display controlling unit 100a lowers (reduces) an evaluation value corresponding to an index other than the index of the icon operated in step 8a, in each table of the use history data 50c. The process shifts to 8i.

In step 8i, the recommendation display controlling unit 100a obtains date and time at which the use of the function corresponding to the icon is started, from the time counted by the control unit 100, associates the obtained time with the icon index as a final use time, and records the time in the final use history data 50f. The process shifts to 8a. The recommendation display controlling unit 100a may detect not the date and time of the start of use, but the time of the end of use and record the time in the final use history data 50f.

Next, the second process will be described, with reference to FIG. 8(b).

In step 8j, the recommendation display controlling unit 100a allows a change key 212 to be displayed in the function key display area 210, as shown in FIG. 2. In accordance with the display of the change key 212, other function keys 211, 213 such as a page feed key and the like are displayed in the function key display area 210. The process shifts to step 8k.

In step 8k, the recommendation display controlling unit 100a determines whether it is a status in which a recommendation display is executed by recommendation display processing in stop 8o to be described later or not. If it is the status in which the recommendation display is executed, the process shifts to step 8m. If it is not the status in which the recommendation display is executed, the process shifts to step 8l.

In step 8l, the recommendation display controlling unit 100a monitors the operation to the operation unit 40 and determines whether the operation to the change key 212 displayed in step 8j is operated by the user or not, i.e. whether a request for change to the recommendation display is made or not. If the request for change to the recommendation display is detected, the process shifts to step 8o. If the request for change to the recommendation display is detected, the process shifts to step 8m.

In step 8m, the recommendation display controlling unit 100a determines whether a timing for updating the recommendation display sequence data 50e comes or not. In other words, the control unit 100 monitors a time elapsing from the previous updating and determines whether the elapsed time exceeds a preset value or not.

If the timing for updating comes, the process shifts to step 8n. If the timing for updating does not come, the process shifts to step 8p.

The control unit 100 determines YES in step 8m every time one hour passes in the example shown in FIG. 3, and every time 0 o'clock AM comes in the example shown in FIG. 4. Alternatively, the control unit 100 may monitor the detection result of the GPS receiving unit 70, and the processing in step 8n may be started if the area in which the mobile terminal is present is changed in longer than a predetermined distance, i.e., if Yes is detected in step 8a.

In step 8n, the recommendation display controlling unit 100a executes updating processing for updating the recommendation display sequence data 50e. The process shifts to step 8o. The updating processing will be described inter with reference to FIG. 9.

In step 8o, the recommendation display controlling unit 100a executes recommendation display processing on the basis of the recommendation display sequence data 50e. The process shifts to step 8p. The recommendation display processing will be described later with reference to FIG. 10.

In step 8p, the recommendation display controlling unit 100a determines whether the user executes an operation for terminating the recommendation display controlling application by unit of the operation unit 40 or not. If it is detected that the terminating operation is executed, the process shifts to step 8g. If it is not detected that the terminating operation is executed, the process shifts to step 8k.

In step 8r, the recommendation display controlling unit 100a determines whether it is a status in which the recommendation display is executed by the recommendation display processing in step 8o or not. If it is the status in which the recommendation display is executed, the process shifts to step 8r. If it is not the status in which the recommendation display is executed, the process is terminated.

In step 8q, the recommendation display controlling unit 100a allows the icons corresponding to the application software, electronic files generated by the application software, the URL of the Web pages and the like to be displayed in the icon display area, terminates the process, and assigns en authority relating to the icon display control to the control unit 100.

Next, the updating processing in step 8m will be described with reference to FIG. 16.

First, in step 9a, the recommendation display controlling unit 100a obtains information of current conditions. The processing shifts to step 9b. In other words, the recommendation display controlling unit 100a obtains time information indicating a current time from the control unit 100, and obtains position information indicating a current position from the GPS receiving unit 70.

In step 9b, the recommendation display controlling unit 100a refers to each table included in the use history data 50c and detects sets of all the indexes corresponding to the current conditions (time information and position information) obtained in step 9a and evaluation values corresponding to the indexes. The processing shifts to step 9c.

In step 9c, the recommendation display controlling unit 100a applies different weights to the evaluation values detected in step 9b, in each table, and adds and sums the evaluation values for each index. The recommendation display controlling unit 100a records the result of summing the evaluation values for each index and the total evaluation value recorded in the excluded icon list data 50b, as a total evaluation value for each index, over the total evaluation value data 50d. The processing shifts to step 9d. The weighting may be arbitrarily preset by the user. If the evaluation values of different tables are to be handled equivalently, the same values may be set as the weights.

In step 9d, the recommendation display controlling unit 100a refers to the information recorded in the total evaluation value data 50d, and executes sorting processing for rearranging each of the total evaluation values and the index corresponding to the total evaluation value in a sequence of higher total evaluation values. The processing shifts to step 9e.

In step 9e, the recommendation display controlling unit 100a records the information (each total evaluation value and the index corresponding to the total evaluation value) sorted in a sequence of a higher total evaluation value in step 9d, over the recommendation display sequence data 50e, and terminates the processing. The processing shifts to step 8o.

Next, the recommendation display processing in step 8n will be described with reference to FIG. 10.

First, in step 10a, the recommendation display controlling unit 100a reads the recommendation display sequence data 50e. The processing shifts to step 10b.

In step 10b, the recommendation display controlling unit 100a urges the index of a higher corresponding total evaluation value to be displayed on the icon display area 200 with priority, on the basis of the recommendation display sequence data 50e read in step 10a, and terminates the processing. For example, the icons displayed in a sequence shown in FIG. 2 are displayed from upper left to right, and then to a lower row in the order on the icon display area 200, as shown in FIG. 11.

In other words, in an example of FIG. 11, an icon represented as “mail” has a highest priority and, subsequently, the icons are displayed in a sequence of “Internet”, “game”, “camera”, “address book”, “dictionary”, “calculator”, . . . “stock price” with a higher priority. If, for example, “mail” of these icons is set to have a higher priority in the excluded icon list data 50b and an excessively great total evaluation value is set, the icon is displayed at an upper position irrespective of its use frequency. On the contrary, if an excessively small total evaluation value is set, the icon is displayed at a position of a lower priority, on a next page or following page.

If the user operates at a position of a “Web” key 214 in the function key display area 210, the recommendation display controlling unit 100a determines that the “Web” 214 has been operated, forms a list of) icons corresponding to the indexes associated with the Web site, of the indexes included in the recommendation display sequence data 50e, and urges the list to be displayed in the icon display area 200 as shown in FIG. 12.

In FIG. 12, displaying title information of the Web page is exemplified. However, the control unit 100 may control the radio communication unit 10 to communicate with the Web site, obtain the latest RSS, extract Meta information in the HTML page, and urge the information and information an a Web site by processing a title by the control unit 100 to be displayed. The user can thereby obtain the latest information on the Web site at a glance.

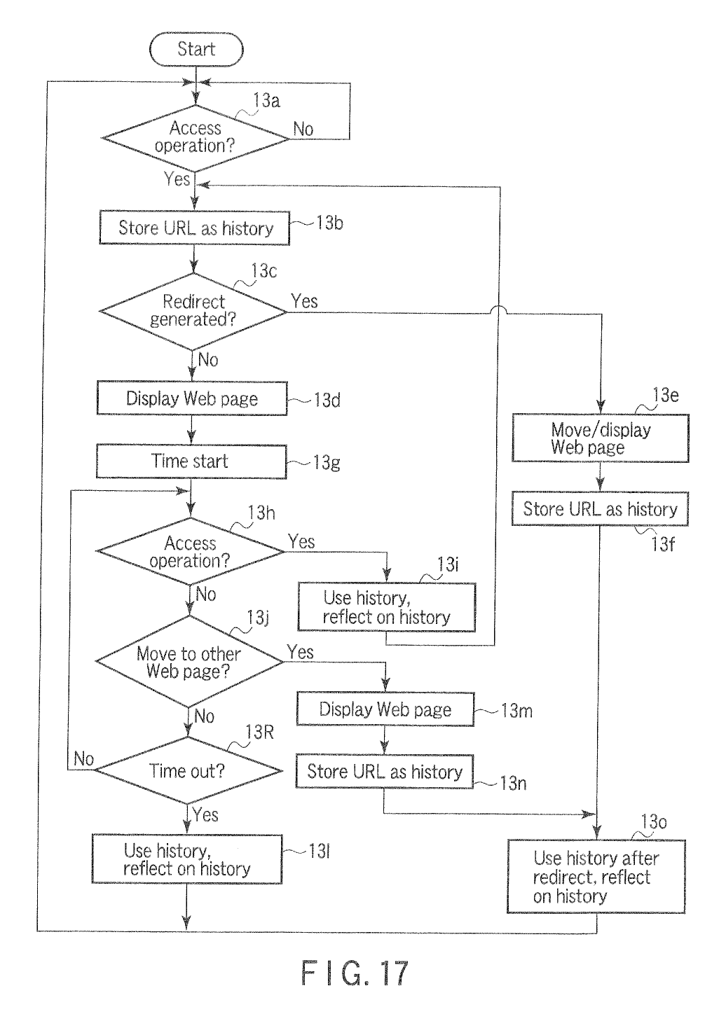

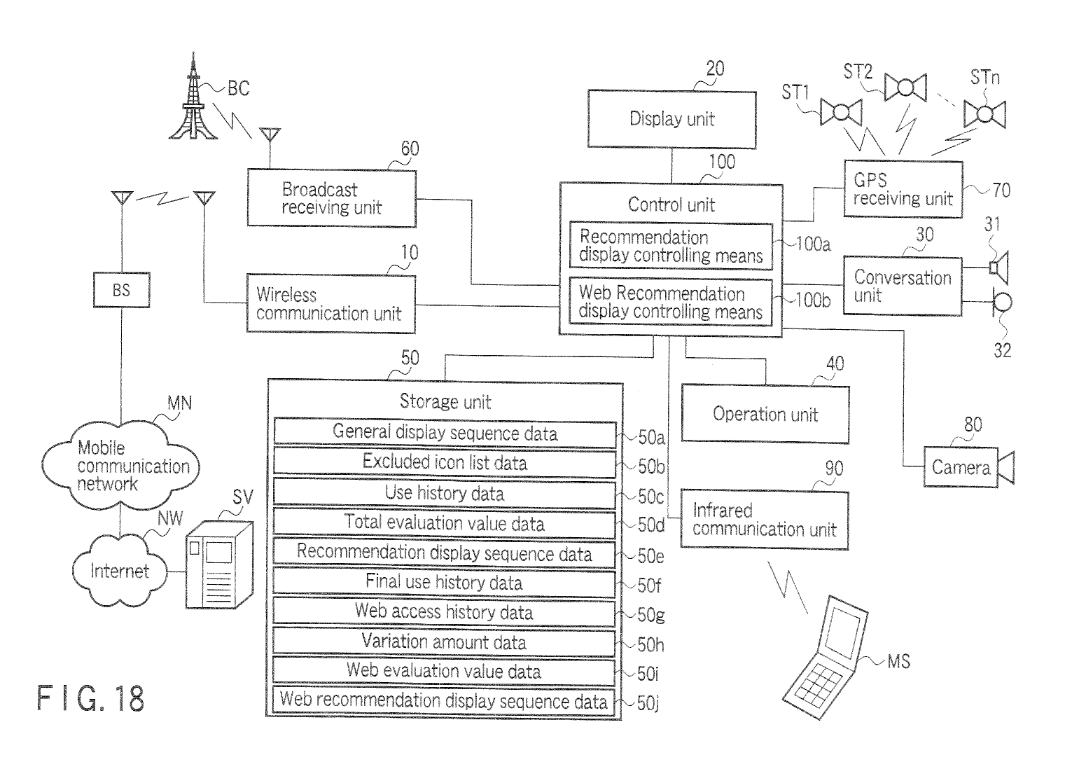

Next, processing of the use history data 50c upon performing Web browsing by using the browser software will be described with reference to FIG. 17. In other words, as for the icon associated with the URL of the Web page, processing of controlling the evaluation value upon accessing the URL will be described. The processing shown in FIG. 17 is executed by the control unit 100 when the browser software is activated, and is repeated until the use of the browser software is stopped.

First, in step 13a, the control unit 100 determines whether an operation to request an access from the currently displayed Web page to the other Web page has been accepted by the user operation, by unit of the operation unit 40. If it is determined that the operation has been accepted, the processing shifts to step 13b. If it is determined that the operation has not been accepted, the control unit 100 continues monitoring the operation again in step 13a.

The above operation indicates, for example, an operation in a case where a URL is input to a URL input field and the access operation is executed, or a case where a hyper link is set to a hyper text displayed on the display unit 20 and an operation to the hyper text is executed by the user.

In step 13b, the control unit 100 records the URL to which an access has been requested in step 13a (or step 13h) in the Web access history data 50g, and accesses the URL of the Web page to which an access has been requested in step 13a (or step 13d to be described later), in predetermined procedures, for example, HTTP (Hyper Text Transport Protocol). Then, the processing shifts to step 13c. The control unit 100 also obtains information such as the time and location at which the connection was executed, and records the information in association with the Web data.

In step 13c, the control unit 100 determines whether information indicating redirect is received from the Web site accessed in step 13b or not. If it is determined that the information indicating redirect is received, the processing shifts to step 13e. If it is determined that the information indicating redirect is not received, the processing shifts to step 13g.

In a case of employing, for example, HTTP as the communication protocol, if 301 (Moved Permanently) or 302 (Moved Temporarily) indicating redirect is received as a status code from the Web site, it is determined that the information indicating redirect is received.

In step 13d, the control unit 100 obtains the Web data from the Web site accessed in step 13b, and urges the Web data to be displayed by unit of the browser software. Then, the processing shifts to step 13g.

In step 13e, the control unit 100 obtains a URL of the connection destination based on the redirect detected in step 13c from the Web site accessed in step 13b, accesses the obtained URL, obtains the Web data and urges the Web data to be displayed by unit of the browser software, in predetermined procedures (for example, HTTP). Then, the processing shifts to step 13f.

In step 13f, the control unit 100 records the URL, of the destination of redirect of step 13e in the Web access history data 50g. Then, the processing shifts to step 13o. The control unit 100 also obtains information such as the time and location at which the connection was executed, and records the information in association with the Web data.

On the other hand, in step 13h, the control unit 100 urges a timer for counting down predetermined time t to be started. Then, the processing shifts to step 13h.

In step 13h, the control unit 100 determines whether an operation to request an access from the currently displayed Web page to the other Web page has been accepted by the user operation, by unit of the operation unit 40. If it is determined that the operation has been accepted, the processing shifts to step 13i. If it is determined that the operation has not been accepted, the control unit 100 continues monitoring the operation again in step 13j.

The above operation indicates, for example, an operation in a case where a URL is input to a URL input field and the access operation is executed, or a case where hyper link is set to a hyper text displayed on the display unit 20 and an operation to the hyper text is executed by the user.

In step 13i, the control unit 100 refers to the icon table stored in the storage unit 50 and confirms whether an icon associated with the URL recorded in step 13c is present in the icon table. If the associated icon is present, the control unit 100 raises the evaluation value associated with the icon index corresponding to the URL, of the icon indexes stored in the use history data 50c, and lowers the evaluation values associated with the other icon indexes. Then, the processing shifts to step 13b. If the associated icon index is not present, the control unit 100 newly adds an evaluation value to the use history data 50c, and associates the icon index with the evaluation value.

At this time, on the basis of the information of the time and location recorded in association with the URL in the Web access history data 50g, the control unit 100 raises each of the evaluation values of the use time zone management table, the use day-of-week management table and the use location management table of the corresponding conditions and lowers the evaluation values associated with the other icon indexes. If the corresponding icon index is not present, an evaluation value is newly added to each of these tables and is associated with the icon index. Then, the processing shifts to step 13b.

In step 13j, the control unit 100 determines whether a process of making an access from the currently accessed URL to a URL of the other Web page is generated in the browser software by unit of a trigger other than the above-described redirect or the user operation (as determined in step 13h). If the process of making an access to the URL of the other Web page is generated, the processing shifts to step 13m. If the process is not generated, the processing shifts to step 13k. The trigger may be META tag or the redirect using the script.

In step 13k, the control unit 100 determines whether the timer started in step is out, i.e. whether the predeterminded time t has elapsed or not. If the time is out, the processing shifts to step 13l to start monitoring of a new access operation. If the time is not out, the processing shifts to step 13h.

In step 13l, the control unit 100 refers to the icon table stored in the storage unit 50 and confirms whether an icon associated with the URL recorded in the Web access history data 50g in step 13c is present in the icon table. If the associated icon is present, the control unit 100 raises the evaluation value associated with the icon index corresponding to the URL associated with the icon of which presence is confirmed, of the Icon indexes stored in the use history data 50c, and lowers the evaluation values associated with the other icon indexes. Then, the processing shifts to step 13a. If the associated icon index is not present, the control unit 100 newly adds an evaluation value, to the use history data 50c, and associates the icon index with the evaluation value.

At this time, on the basis of the information of the time and location recorded in association with the URL in the Web access history data 50q, the control unit 100 raises each of the evaluation values of the use time zone management table, the use day-of-week management table and the use location management table of the corresponding conditions and lowers the evaluation values associated with the other icon indexes. If the corresponding icon index is not present, an evaluation value is newly added to each of these tables and is associated with the icon index. Then, the processing shifts to step 13a.

In step 13m, the control unit 100 executes the process generated in step 13j, obtains a URL of a new connection destination, accesses the obtained URL, obtains the Web data and urges the Web data to be displayed by unit of the browser software. Then, the processing shifts to step 13n.

In step 13n, the control unit 100 records the URL, obtained in step his in the Web access history data 50g. Then, the processing shifts to step 13o. The control unit 100 also obtains information such as the time and location at which the connection was executed, and records the information in association with the Web data.

In step 13o, the control unit 100 refers to the icon table stored in the storage unit 50 and confirms whether an icon associated with the URL recorded in step 13f or 13n is present in the icon table. If the associated icon is present, the control unit 100 raises the evaluation value associated with the icon index corresponding to the URL associated with the icon of which presence is confirmed, of the icon indexes stored in the use history data 50c, and lowers the evaluation values associated with the other icon indexes. Then, the processing shifts to step 13a. If the associated icon index is not present, the control unit 100 newly adds an evaluation value to the use history data 50c, and associates the icon index with the evaluation value.

At this time, on the basis of the information of the time and location recorded in association with the URL in the Web access history data 50g, the control unit 100 raises each of the evaluation values of the use time zone management table, the use day-of-week management table and the use location management table of the corresponding conditions and lowers the evaluation values associated with the other icon indexes. If the corresponding icon index is not present, an evaluation value is newly added to each of these tables and is associated with the icon index. Then, the processing shifts to step 13a.

In other words, in step 13o, not the URL to which access is requested by the user in step 13a, but the URL accessed irrespective of the user instruction, for the redirect from the URL to which access is requested or the other reasons, is reflected on the evaluation values in the use history data 50c, on the basis of the access to the Web page of the URL to which access is requested, while the URL to which access is requested by the user is not reflected on the evaluation values in the use history data 50c.

According to the mobile terminal having the above-described structure, the use histories of the functions used by the user are stored and, on the basis of the use histories, display arrangement of the icons for using the functions is controlled. Therefore, since the display arrangement of the icons is changed in accordance with the use frequency of the user, the mobile terminal has a high usability for the user.

In addition, the evaluation values indicating the frequencies of a plurality of use conditions such as the time zone of use, the day of week of use, location of use, and the like are recorded as the use histories. On the basis of the evaluation values according to the current conditions (time zone, day of week, location), the functions which would be used at a higher possibility by the user is inferred and the display arrangement of the icons is controlled.

For this reason, since the display arrangement of the icons is controlled, on the basis of the current conditions and the use histories of the past time, the mobile terminal has a high usability for the user. In addition, the functions which would be used at a higher possibility by the user are inferred by considering a plurality of conditions (time zone, day of week, location). Even if sufficient use histories are not accumulated under some of the conditions, the functions can be inferred under the other conditions. Therefore, deterioration of the usability can be restricted.

Furthermore, the total evaluation value obtained by weighting under a plurality of conditions a accumulated as the use histories, and the functions which would be used at a higher possibility by the user are inferred on the basis of the total evaluation value. For this reason, the functions can be inferred by considering the weighting under a plurality of conditions. Therefore, the user usability can be improved at a higher accuracy.

In addition, the excluded icon list data 50b are stored in the mobile terminal, and the icon index stored in the data is not subjected to the recommendation display control. For this reason, the icons can displayed except the icon index by the function of a higher use frequency or displayed with priority by the function of a lower use frequency.

In the mobile terminal having the above-described structure, not the URL to which access is requested by the user in step 13a, but the URL accessed irrespective of the user instruction, for the redirect from the URL to which access is requested or the other reasons, of the URL accessed by the browser software, is reflected on the evaluation values in the use history data 50c, on the basis of the access to the Web page of the URL to which access is requested, while the URL to which access is requested by the user is not reflected on the evaluation values in the use history data 50c.

For this reason, since the finally viewed Web page, of the Web pages accessed in response to the user's request, is reflected on the evaluation values in the use history data 50c, the icon corresponding to the Web page which is originally desired by the user is displayed with priority, and the usability is thereby improved.

The present embodiment is not limited to the embodiments described above but the constituent elements of the embodiment can be modified in various manners without departing from the spirit and scope of the embodiment. Various aspects of the embodiment can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

For example, in the above-described embodiment,

the URL accessed irrespective of the user instruction, for the redirect or the other reasons, of the URL recorded in the Web access history data 50g, is reflected on the evaluation values in the use history data 50c, in the processing shown in FIG. 17. Instead of this, for example, the URL stored in step 13c may be deleted to record the other accessed URL alone in the Web access history data 50g.

In addition, a smartphone has been exemplified in the above-described embodiment. However, the embodiment can be widely applied to devices which display the functions by the icons, such as other types of mobile telephones, PDA (Personal Digital Assistants), notebook type personal computers and the like.

It goes without saying that the present embodiment can also be variously modified within a scope which does not depart from the gist of the present embodiment.

### Third Embodiment

Next, a third embodiment will be described.

A mobile terminal according to the third embodiment has apparently the same structure as the mobile terminal according to the first embodiment shown in FIG. 1. Thus, only different constituent elements (storage unit 50 and control unit 100) from the constituent elements of the first embodiment will be described, and explanations of the same constituent elements are the same as the explanations made in the first, embodiment.

The mobile terminal according to the third embodiment comprises a control unit 100, a wireless communication unit 10, a display unit 20, conversation unit 30, an operation unit 40, a storage unit 50, a broadcast receiving unit 60, a GPS receiving unit 70, a digital camera 80, and an infrared communication unit 90 as main constituent elements. As main functions, the mobile terminal comprises a communication function of executing speech communication and data communication via a base station apparatus BS and a mobile communication network MN, a broadcast reception function of receiving ground digital broadcast signal transmitted from a broadcast station BS, a positioning function of positioning an own position, and an infrared communication function of executing infrared communication with the other mobile telephone MS, and also comprises a function of executing application software using these functions. Besides these functions, the mobile terminal comprises a function of executing credit-card transactions by non-contact type near-distance wireless communication such as Bluetooth (registered trademark), an electronic money function of payment for use of transportation and product purchase, and the like.

The storage unit 50 stores control programs and control data of the control unit 100, application software, address data associated with names, telephone numbers, and the like of the other communication parties, data of transmitted and received emails, Web data downloaded by Web browsing, and downloaded content data, and temporarily stores streaming data, and the like. The storage unit 50 comprises one or more storage unit such as HDD, and semiconductor memories of RAM, ROM, and the like.

In addition, the storage unit 50 stores excluded con list data 50b, use history data 50c, total evaluation value data 50d, recommendation display sequence data 50e, final use history data 50f, and Web access history data 50g as control data to implement recommendation display control to be described later, besides general display sequence data 50a. These data elements are the same as those of the first or second embodiment, and their explanations are omitted here.

Furthermore, the storage unit 50 stores variation amount data 50h, Web evaluation value data 50i, and Web recommendation display sequence data 50j. Besides these, the storage unit 50 stores data with bookmarks formed by listing a plurality of URL arbitrarily registered by the user.

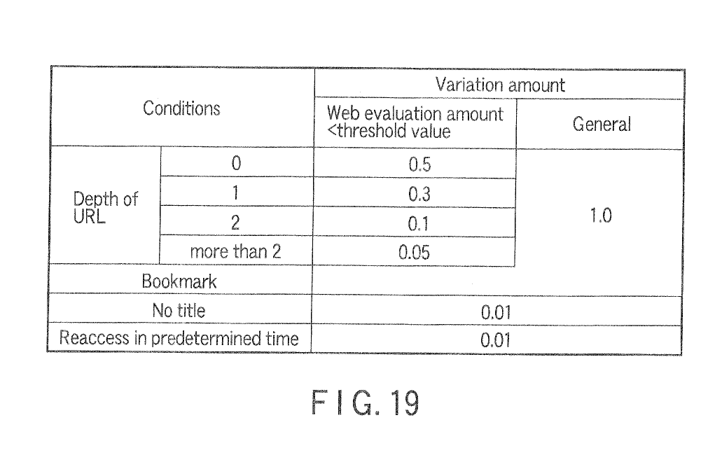

The variation amount data 50h are a variation amount table as shown in FIG. 19. In the table, various conditions are associated with variation amount k. The variation amount k is a weighting factor used for calculation of a Web evaluation value V to be described later.

The Web evaluation value data 50i are the Web evaluation value V for each of accessed. URL. The Web evaluation value V is an index indicating usefulness for the user.

The Web recommendation display sequence data 50j are data indicating a sequence of displaying histories of accessed URL as determined on the basis of the Web evaluation value data 50i by the control unit 100.

The control unit 100 comprises a microprocessor, operates under the control programs and control data stored in the storage unit 50, and controls each of the units in the mobile radio terminal. The control unit 100 also comprises, for example, a communication controlling function for controlling each of the units of the commutation system to execute the speech communication and data communication, and an application processing function for executing mail software which creates, transmits and receives electronic mails, browser software which executes Web browsing, media reproduction software which downloads and reproduces streaming data, broadcast reception software which receives the ground digital broadcast signal transmitted from the broadcast station BC, image processing software which controls the digital camera 80 to execute photographing, and image analysis software which decodes a QR (Quick Response) code (registered trademark) by image analysis, and controlling each of the units associated with the software.

In addition, the control unit 100 detects an operation for the icon displayed on the display unit 20 on the basis of the detection result of the operation unit 40. If the operation requires activation, the control unit 100 executes a function associated with the icon.

For example, if the application software is associated with the operated icon, the control unit 100 reads out the associated application software from the storage unit 50 and executes the associated application software.

In addition for example, if an electronic file is associated with the operated icon, the control unit 100 reads out the application software for using (viewing or editing) the associated electronic file from the storage unit 50 and executes the application software.

For example, if the URL of the Web page is associated with the operated icon, the control unit 100 activates the browser software, starts communications by unit of the wireless communication unit 10, accesses a server SV storing the information corresponding to the URL over the Internet NW to obtain Web data and the like, and urges the information to be displayed on the display unit 20 by the browser software. In other words, the control unit 100 accesses the URL and allows the user to view the information.

The control unit 100 comprises recommendation display cone rolling unit 100a. This function is the some as that explained in the first or second embodiment, and it explanation is omitted here.

Furthermore, the control unit 100 comprises Web recommendation display controlling unit 100a. This function is implemented by reading and executing a Web recommendation display control application stored in the storage unit 50 by the control unit 100. This function analyzes and evaluates the user's use history under various conditions, and displays a list of recommended Web sites in a sequence according to a result of the evaluation. When a title is selected from the list, connection to the associated Web site is started.

Next, the operation of the mobile terminal according to the third embodiment will be described.

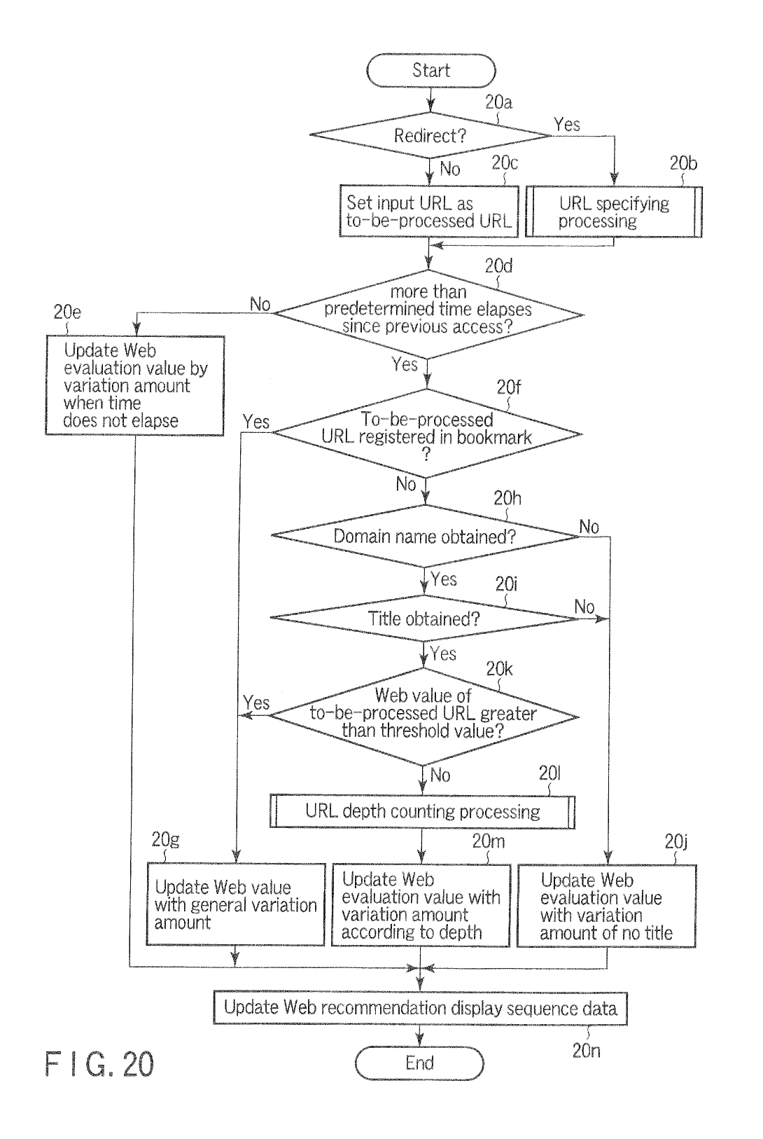

In the following descriptions, an explanation of the operation of the recommendation display controlling unit 100a is omitted here, and the first or second embodiment should be reviewed. The following descriptions are particularly focused on an operation of Web recommendation display control. FIG. 20 is flowchart showing the operation of the Web recommendation display control.

These processes are executed by unit of Web recommendation display controlling unit 100b, by reading and executing the Web recommendation display control application stored in the storage unit 30 by the control unit 100, and executed on a background simultaneously with the browser software and the processing shown in FIG. 17.

More specifically, in a case where the URL is input in the browser software or a desired URL is selected from a list of URL registered in a bookmark, by the user operation using the operation unit 40, if the browser software accesses a Web page corresponding to the URL (hereinafter called input URL), processing of FIG. 20 is started.

First, in stet) 20a, the Web recommendation display controlling unit 100b determines whether redirect is generated on the Web page of the input URL accessed by the browser software, and the browser software accesses a Neb page of a different URL (hereinafter called redirect URL) or not. If the redirect is generated and the browser software accesses the Web page of the URL, the processing shifts to step 20b. If the redirect is not generated and the browser software remains accessing the Web page of the input URL, the processing shifts to step 20c.

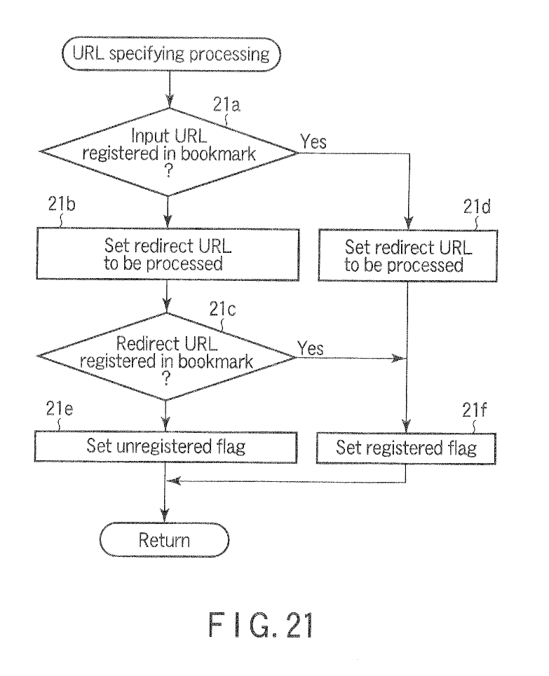

In step 20b, the Web recommendation display controlling unit 100b executes URL specifying processing of specifying a URL to be subjected to processing (hereinafter called to-be-processed URL), in the processing of FIG. 20, Then, the processing shifts to step 20d. Details of the URL specifying processing are shown in FIG. 21. With reference to FIG. 21, the URL, specifying processing will be explained.

In step 21a, the Web recommendation display controlling unit 100b determines whether the input URL is registered in the bookmark or not. If the input URL is registered in the bookmark, the processing shifts to step 21c. If the input URL is not registered in the bookmark, the processing shifts to step 21b.

In step 21b, the Web recommendation display controlling unit 100b sets the redirect URL as the to-be-processed UPS. Then, the processing shifts to step 21c.

In step 21c, the Web recommendation display controlling unit 100b determines whether the redirect URL is registered in the bookmark or not. If the redirect URL is registered in the bookmark, the processing shifts to step 21f. If the redirect URL is not registered in the bookmark, the processing shifts to step 21e.

In step 21d, the Web recommendation display controlling unit 100b sets the input URL as the to-be-processed UPS. Then, the processing shifts to step 21f.

In step 21e, the Web recommendation display controlling unit 100b sets a non-registration flag indicating that the to-be-processed URL is not registered in the bookmark and terminates the processing. Then, the processing shifts to step 20d.

In step 21f, the Web recommendation display controlling unit 100b sets a registration flag indicating that the to-be-processed URL is registered in the bookmark and terminates the processing. Then, the processing shifts to step 20d.

The processing of FIG. 20 will be explained again.

In step 20c, the Web recommendation display controlling unit 100b sets the input. URL as the to-be-processed URL. Then, the processing shifts to step 20d.

In step 20d, the Web recommendation display controlling unit 100h refers to the Web access history data 50g, detects a time at which the to-be-processed URL was last accessed, compares the detected time with the current time, and determines whether a time equal to or longer than a predetermined time elapses or not. If the time equal to or longer than the predetermined time elapses, the processing shifts to step 20f. If the time equal to or longer than the predetermined time does not elapse, the processing shifts to step 20e.

In step 20e, the Web recommendation display controlling unit 100h reads a variation amount k corresponding to the to-be-processed URL from the variation amount data 50h since the to-be-processed URL is the URL accessed again before the time equal to or longer than the predetermined time elapses. In the variation amount data 50h shown in FIG. 19, the variation amount k=0.01 is set.

Furthermore, the Web recommendation display controlling unit 100h reads a Web evaluation value V associated with the to-be-processed URL, as Vu, from the Web evaluation value data 50i, updates the Web evaluation value V in the following equation (1), and records the updated Web evaluation value in the Web evaluation value data 50i. As for the URL of which Web evaluation value V is recorded in the Web evaluation value data 50i, other than the to-be-processed URL, the Web recommendation display controlling unit 100b updates the Web evaluation value V in the following equation (2) and records the updated Web evaluation value in the Web evaluation value data 50i. Then, the processing shifts to step 20n. α represents a learning rate which is a positive real number equal to or smaller than 1.

V=(1−α)Vo+αk (1)

V=(1−α)Vo (2)

In step 20f, the Web recommendation display controlling unit 100b determines whether the to-be-processed URL is registered in the bookmark or not. If the to-be-processed URL is registered in the bookmark, the processing shifts to step 20g. If the to-be-processed URL is not registered in the bookmark, the processing shifts to step 20h. If the non-registration flag is set in step 21e, the processing shifts to step 20h. On the other hand, if the registration flag is set in step 21f, the processing shifts to step 20g.

In step 20g, the Web recommendation display controlling unit 100b reads a variation amount k corresponding to the to-be-processed URL, from the variation amount data 50h since the to-be-processed URL is registered in the bookmark, In the variation amount data 50h shown in FIG. 19, the variation amount k=1.0 is set.

Furthermore, the Web recommendation display controlling unit 100b reads the Web evaluation value. V associated with the to-be-processed URL, as Vo, from the Web evaluation value data 50i, updates the Web evaluation value V in the equation (1), and records the updated Web evaluation value in the Web evaluation value data 50i, As for the URL of which Web evaluation value. V is recorded in the Web evaluation value data 50i, other than the to-be-processed URL, the Web recommendation display controlling unit 100b updates the Web evaluation value V in the equation (2) and records the updated Web evaluation value in the Web evaluation value data 50i. Then, the processing shifts to step 20n.

In step 20h, the Web recommendation display controlling unit 100b determines whether, when the browser software accesses the Web page of the to-be-processed URL, the domain name is obtained from the to-be-processed URL on the Web page or not. If the domain name is obtained, the processing shifts to step 20i. If the domain name is not obtained, i.e. if the to-be-processed URL is an IP address or the like, the processing shifts to step 20j. The determination is executed by noticing the matter that domain names are rarely assigned to hazardous sites and malicious sites.

In step 20i, the Web recommendation display controlling unit 100b determines whether, when the browser software accesses the Web page of the to-be-processed URL, the title of the Web page is obtained from the content of the Web page or not. If the title is obtained, the processing shifts to step 20k. If the title is not obtained, the processing shifts to step 20j. The determination is executed by considering the user's usability since the site to which no title is assigned is not easily understandable for the user.

In step 20j, the Web recommendation display controlling unit 100b reads a variation amount k corresponding to the to-be-processed URL from the variation amount data 50i since the domain name or title cannot be obtained from the to-be-processed URL. In the variation amount data 50h shown in FIG. 19, the variation amount K=0.01 is set.

Furthermore, the Web recommendation display controlling unit 100h reads the Web evaluation value V associated with the to-be-processed URL, as Vo, from the Web evaluation value data 50i, updates the Web evaluation value V in the equation (1), and records the updated We evaluation value in the Web evaluation value data 50i. As for the URL of which Web evaluation value V is recorded in the Web evaluation value data 50i, other than the to-be-processed URL, the Web recommendation display controlling unit 100h updates the Web evaluation value V in the equation (2) and records the updated Web evaluation value in the Web evaluation value data 50i. Then, the processing shifts to step 20n.

In step 20k, the Web recommendation display controlling unit 100b reads the Web evaluation value V associated with the to-be-processed URL from the Web evaluation value data 50i, and determines whether the Web evaluation value V is equal to or smaller than a threshold value or not. If the Web evaluation value V is equal to or greater than the threshold value, the processing shifts to step 20g. If the Web evaluation value V is smaller than the threshold value, the processing shifts to step 20l.

In step 20l, the Web recommendation display controlling unit 100b executes URL depth counting processing. Then, the processing shifts to step 20m. In general, the Web site has a hierarchic structure, The Web page in a deeper hierarchy has a longer URL. In addition, a boundary between the hierarchies is generally represented by a separation symbol such as “/” or “?”.

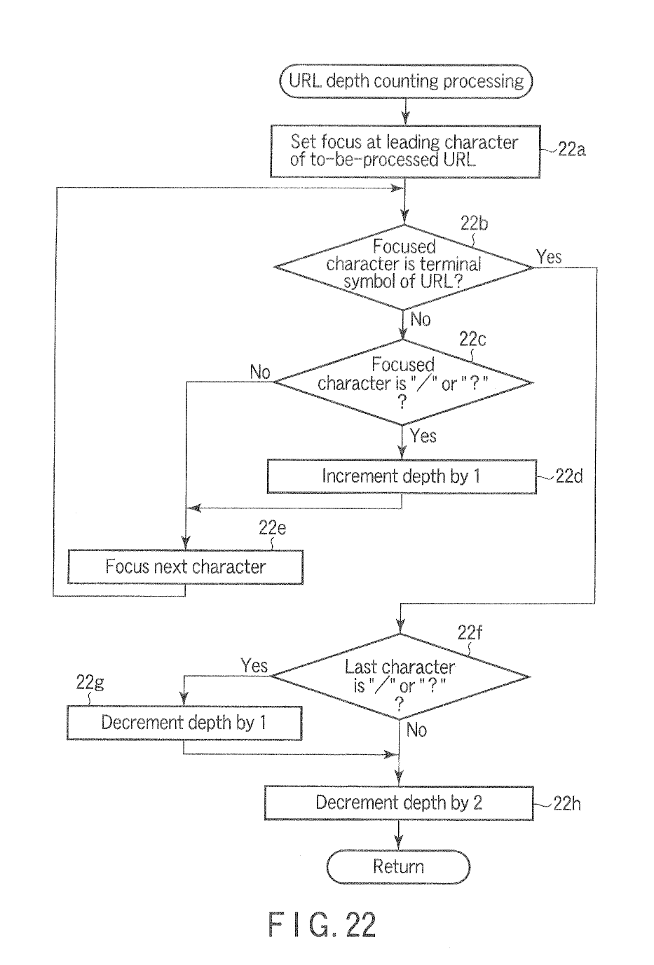

Then, the URL depth counting processing counts a depth D indicating the depth of the directory (depth) in the Web site of the to-be-processed URL. Details of the URL depth counting processing are shown in FIG. 22. The URL depth counting processing will be described here with reference to FIG. 22.

In step 22a, the Web recommendation display controlling unit 100b sets a focus indicating character to be determined, at d leading character of a character string constituting the to-be-processed URL. Then, the processing shifts to step 22b.

In step 22b, the Web recommendation display controlling unit 100b determines whether the focused character is a terminal symbol set at a terminal of the URL or not. If the focused character is the terminal symbol, the processing shifts to step 22f. If the focused character is not the terminal symbol, the processing shifts to step 22c.

In step 22c, the Web recommendation display controlling unit 100b determines whether the focused character is a specific symbol “/” or “?” or not. If the focused character is the specific symbol, the processing shifts to step 22d. If the focused character is not the specific symbol, the processing shifts to step 22e. In general, the specific symbol is used to separate the hierarchies.

In step 22d, the Web recommendation display controlling unit 100b increments the depth D by 1. Then, the processing shifts to step 22e.

In step 22e, the Web recommendation display controlling unit 100b sets a focus on a next character following the character at which the focus is currently set, in the character string constituting the to-be-processed URL. Then, the processing shifts to step 22h.

In step 22f, the Web recommendation display controlling unit 100b determines whether the character immediately before the terminal symbol in the character string constituting the to-be-processed URL is the specific symbol “/” or “?” or not. If the character immediately before the terminal symbol is the specific symbol, the processing shifts to step 22g. If the character immediately before the terminal symbol is not the specific symbol, the processing shifts to step 22h.

In step 22g, the Web recommendation display controlling unit 100b decrements the depth D by 1. Then, the processing shifts to step 22h. The URL is handled in the same manner if the character immediately before the terminal symbol is present or not. Therefore, when the specific symbol is present at the terminal part, the depth is decremented to the degree corresponding thereto such that the depth is counted in either situation.

In step 22h, the Web recommendation display controlling unit 100b decrements the depth D by 2. Then, the processing terminates and shifts to step 20m. Since the URL generally starts with “http://”, the depth D is decremented to the degree corresponding thereto.

The processing will be described again with reference to FIG. 20.

In step 20m, the Web recommendation display controlling unit 100b reads the variation amount k corresponding to the depth D obtained in step 20l, from the variation amount data 50h. In the variation amount data 50h shown in FIG. 19, the variation amount k=0.5 is set if the depth D is 0, the variation amount k=0.3 is set if the depth D is 1, the variation amount k=0.1 is set if the depth D is 2, and the variation amount k=0.05 is set if the depth. D is equal to or greater than 3.

Furthermore, the Web recommendation display controlling unit 100b reads the Web evaluation value V associated with the to-be-processed URL, as Vo, from the Web evaluation value data 50i, updates the Web evaluation value V in the equation (1), and records the updated Web evaluation value in the Web evaluation value data 50i. As for the URL of which Web evaluation value V is recorded in the Web evaluation value data 50i, other than the to-be-processed URL, the Web recommendation display controlling unit 100b updates the Web evaluation value V in the equation (2) and records the updated. Web evaluation value in the Web evaluation value data 50i. Then, the processing shifts to step 20n.

In step 20n, the Web recommendation display controlling unit 100b determines a sequence of displaying the histories of the accessed URL on the basis of the Web evaluation value data 50i, and records the data indicating the display sequence in the Web recommendation display sequence data 50j. Then the processing is terminated. The display sequence is set such that the history of the URL is displayed with a higher priority as the Web evaluation value is higher.

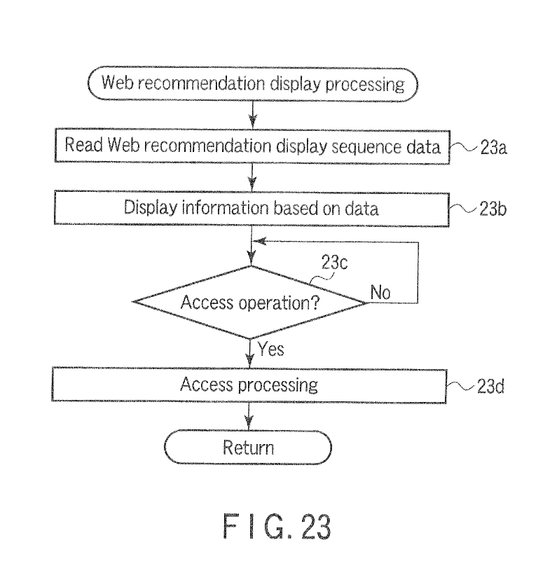

Next, the Web recommendation display processing will be described with reference to FIG. 23. The processing is, for example, started by a request from the user by unit of the operation unit 40 and executed by the Web recommendation display controlling unit 100b.

First, in step 23a, the Web recommendation display controlling unit 100b reads the Web recommendation display sequence data 50j. Then, the processing shifts to step 23h.

In step 23h, the Web recommendation display controlling unit 100b forms a list of indexes (captions) of the URL having high Web evaluation values and displays the list on the display unit 20, with priority, on the basis of the Web recommendation display sequence data 50j read in step 23a. Then, the processing shifts to step 23c. The title information of the Web pages is displayed together with the indexes.

Displaying the indexes together with the title information of the Web pages has been explained, above. However, the control unit 100 may control the wireless communication unit 10 to communicate with the Web site, obtain a latest RSS, extract Meta information in a HTML page, and display the extracted information and the information on the Web site obtained by processing the titles by the control unit 100. The user can thereby obtain the latest information on the Web site at a glance.

In step 23c, the Web recommendation display controlling unit 100b determines whether an operation of requesting an access to any one of the URL listed and displayed in step 23b, is executed by unit of the operation unit 40 by the user or not. If it is detected on the basis of the detection result of the operation unit 40 that the operation is executed, the processing shifts to step 23d. If it is detected that the operation is not executed, the Web recommendation display controlling unit 100b continues monitoring the user operation.

In step 23d, the Web recommendation display controlling unit 100b sets the URL to which an access is requested in step 23c, in the browser software, and accesses the Web site, and terminates the processing.

In the mobile terminal of the above-described structure, if the Web page is viewed, the Web evaluation value of foe Web page using the variation amount as the parameter is obtained, and a list of the previously accessed Web pages is displayed in the sequence based on the Web evaluation values of the respective viewed Web pages. The evaluation amount is set such that the Web evaluation value is higher as the depth of the hierarchy of the Web page is smaller.

Therefore, according to the mobile terminal, since the list of the previously accessed Web pages can be displayed in accordance with the depth of the hierarchies of the Web pages, the Web pages in upper hierarchies are displayed at upper positions of the list, with priority, on the same homepage. The usability is therefore high for the user.

In addition, if the Web evaluation value is not above a preset threshold value, the variation amount is varied to be lower than the general value such that the rate of increase in the Web evaluation value is restricted relatively to the general case. For this reason, as for the Web page associated with the Web evaluation value which reaches the threshold value, the rate of increase in the Web evaluation value is increased relatively to the other Web page.

In general, most of Web pages on news columns and the like are accessed at only one time but a Web page accessed at a plurality of times is regarded as a page which is worth being repeatedly accessed (for example, a top page of a portal site). Therefore, the Web) evaluation value of the Web page which reaches the threshold value can be set to be higher as compared with the Web page of a lower access frequency, by the above processing.

If the domain name or title is not included in the Web page, a relatively smaller variation amount is set as compared with the other Web page. Therefore, the increase in the Web variation value is restricted relatively to the other Web page. An access to a Web page which may cause phishing and the like at a high possibility can be thereby restricted.

In addition, as for the Web page which is accessed again in a predetermined period, a relatively smaller variation amount is set as compared with the other Web page. Therefore, the increase in the Web variation value is restricted relative iv to the other Web page. For this reason, even if the same Web page is accessed again by operating a software key such as “return” on the browser software, the access is estimated to be low and reflected on the Web evaluation value.

The present embodiment is not limited to the embodiments described above but the constituent elements of the embodiment can be modified in various manners without departing from the spirit and scope of the embodiment. Various aspects of the embodiment can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

For example, in the processing in FIG. 23, the indexes of the URL having higher Web evaluation values are listed and displayed on the display unit 20, with priority, on the basis of the Web evaluation value calculated by considering the variation amount. In the recommendation display processing, however, the display sequence of the icons for accessing the Web pages may be controlled in the sequence using the Web evaluation values.

In addition, the indexes are listed and displayed. However, the only index of the Web page in the uppermost order may be displayed, and the index of the Web page in the next order may be displayed in accordance with the user operation. In other words, one or a plurality of Web pages may be selectively displayed in the order of higher Web evaluation values, in response to the user operation.

It goes without saying that the present embodiment can also be variously modified within a scope which does not, depart from the gist of the present embodiment.

While certain embodiments have been described, these embodiments have been presented by way of example only, and are not intended to limit the scope of the inventions. Indeed, the novel embodiments described herein may be embodied in a variety of other forums; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A mobile terminal, capable of viewing a Web page, comprising:
a storing unit configured to store an access history of the Web page; and
a history recording unit configured to record the access history of the Web page in the storage unit and, upon moving from the Web page to a Web page having other identification information after access, record an access history of the Web page corresponding to the other identification information in the storage unit.

2. The mobile terminal of claim 1, wherein, upon detecting a status code to move to the Web page having the other identification information after the access, the history recording unit records in the storing unit the access history of the Web page correspond to the other identification information.

3. The mobile terminal of claim 1, wherein, upon moving to the Web page having the other identification information within a preset determined period after the access, the history recording unit records in the storing unit the access history of the Web page corresponding to the other identification information.

4. The mobile terminal of claim 1, wherein, upon moving to the Web page having the other identification information without a direction from a user, the history recording unit records in the storing unit the access history of the Web page corresponding to the other identification information.

5. The mobile terminal of claim 1, wherein the history recording unit records the access history of the Web page in the storing unit and, upon moving to the Web page having the other identification information after the access, records the access history of the Web page corresponding to the other identification information in the storing unit, and deletes in the storing unit an access history of an access made immediately before accessing the Web page corresponding to the other identification information.

6. The mobile terminal of claim 5, wherein, upon detecting a status code to move to the Web page having the other identification information after the access, the history recording unit records in the storing unit the access history of the Web page corresponding to the other identification information.

7. The mobile terminal of claim 5, wherein, upon moving to the Web page having the other identification information within a preset determined period after the access, the history recording unit records in the storing unit the access history of the Web page corresponding to the other identification information.

8. The mobile terminal of claim 5, wherein, upon moving to the Web page having the other identification information without a direction from a user, the history recording unit records in the storing unit the access history of the Web page corresponding to the other identification information.

9. A mobile terminal capable of viewing a page, comprising:
a viewing unit configured to connect to a Web site and view a Web page in a hierarchical structure;
a depth detecting unit configured to detect a depth of hierarchy of the Web page viewed by the viewing unit from a URL;
an evaluation value detecting unit configured to obtain an evaluation value of the Web page from the depth detected by the depth detecting unit; and
a display control unit configured to display a title of the Web page in a priority order based on the evaluation value detected by the evaluation value detecting unit.

10. The mobile terminal of claim 9, wherein the evaluation value detecting unit comprises:
a weighting factor setting unit configured to set a weighting factor corresponding to the depth detected by the depth detecting unit; and
an evaluation value determining unit configured to obtain the evaluation vaiue of the Web page in accordance with the weighting factor set by the weighting factor setting unit.

11. The mobile terminal of claim 10, wherein if the evaluation value obtained at a previous time is above a preset threshold value, the weighting factor setting unit sets a higher value of the weighting factor than a value in a case where the evaluation value is not above the threshold value.

12. The mobile terminal of claim 10, wherein if the Web page is viewed by the viewing unit and a domain name of the Web page is unable to be obtained, the weighting factor setting unit sets a lower value of the weighting factor than a value in a case where the domain name is able to be obtained.

13. The mobile terminal of claim 10, wherein if the Web page is viewed by the viewing unit and a title of the Web page is unable to be obtained, the weighting factor setting unit sets a lower value of the weighting factor than a value in a case where the title is able to be obtained.

14. The mobile terminal of claim 10, wherein if the same Web page is viewed in a predetermined period by the viewing unit, the weighting factor setting unit sets a lower value of the weighting factor than a value in a case where the same Web page is viewed after the predetermined period elapses.
